(19) United States
(12) Patent Application Publication
(10) Pub. No.: US 2009/0011143 A1
(43) Pub. Date: Jan. 8, 2009

(54) PATTERN FORMING APPARATUS AND PATTERN FORMING METHOD

(75) Inventors: Ryuuichi YATSUNAMI, Fukuoka (JP); Satoru MIYANISHI, Fukuoka (JP); Yasuhiro NOTOHARA, Fukuoka (JP); Hisahiro TANAKA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/142,857

(22) Filed: Jun. 20, 2008

(30) Foreign Application Priority Data
Jun. 22, 2007 (JP) P2007-164619
Jun. 25, 2007 (JP) P2007-165812

(51) Int. Cl. B05D 3/06; B05C 5/00; B05C 11/00

(52) U.S. Cl. 427/555; 118/620; 118/708

(57) ABSTRACT

A pattern forming apparatus includes a liquid material application mechanism that includes an opening for applying a liquid material on a substrate, and a laser processing mechanism that includes an irradiation section for irradiating the liquid material applied on the substrate with laser light to immobilize the liquid material so that a pattern is formed. The laser processing mechanism is integrated with the liquid material application mechanism.

### BACKGROUND

The present invention relates to a pattern forming apparatus and a pattern forming method for forming a pattern on a solid surface using a functional liquid material and the like which are capable of forming an electronic device.

For conventional functional device manufacturing methods that form integrated circuits on silicon wafers using a micromachining technique such as a vacuum process and photolithography, a number of methods for manufacturing functional devices using so-called print electronics based on new material and process that combine liquid material, such as a solution of organic material or a colloidal solution of inorganic material, and a printing technique have been proposed.

As one of printing techniques used for the print electronics, an inkjet method has been widely reviewed and used although all methods for printing images on paper are possible.

The inkjet method, which is a technique that has been developed as a printing method for a small-sized printer for use in home, performs a drawing operation by ejecting ink on paper from minute nozzles while scanning the paper with the minute nozzles based on electronic data sent from a computer, a digital camera or the like.

The inkjet method is greatly different from a method for printing and copying books, magazines, newspapers and the like in great quantities using a negative plate.

The printing method using the negative plate is highly suitable for printing same objects such as newspapers at a high speed and in great quantities. However, even in case of printing an object in small quantities, this printing method requires the same negative plate as in the mass printing and produces prints identical with the negative plate.

On the contrary, the inkjet method uses no negative plate and original print information used in the inkjet method is simple electronic data which can be simply changed. Accordingly, the inkjet method is very effective for preparing various kinds of prints. For example, this may be true of printing of photographs made by a digital camera for home use. Although disadvantageous in terms of a printing speed as compared to the printing method using the negative plate, this inkjet printing method requires no effort and cost for preparation of the negative plate and accordingly can flexibly cope with various different kinds of prints.

Electronics devices are transitioning from mass production of same objects to small quantity batch production according to diversification of consumer needs. Print electronics appeared with such circumferences as backgrounds are attracting a great attention as a technique having possibility to manufacture various kinds of electronics devices in small qualities on demand according to consumer needs in combination with the inkjet method. For example, if different devices such as readable RFID (Radio Frequency Identification) tags have different ID information, that is, different wiring patterns, the inkjet printing method can flexibly cope with such devices by properly changing contents of electronic data sent to an inkjet printer.

A number of techniques related to the inkjet printing method having such an advantage have been proposed. For example, an application of the inkjet printing method to an organic EL display requiring complicated patterning using a plurality of materials has been proposed (see Patent Document 1).

However, a drawing by the inkjet method has several problems due to its operation principle. First, a figure drawn by the inkjet method, which is a collection of points, has ununiformity at boundaries between points on the principle that minute droplets are ejected from minute nozzles. In addition, the ejected droplets may be affected by external disturbances such as an air stream, static electricity and the like until they reach a target point, which results in deviation of the droplets from the target point. In addition, even if the droplets reached the target point, the droplets may be drenched and spread into a reach plane or be repelled from the reach plane, which results in unintended drawing. In an extreme case, the droplets will not well be discharged such that drawing is not possible.

In this manner, the pattern formation by the inkjet method has problems in that a surface of the formed pattern is not smooth or has a defect, or droplets are deviated from a target point. Such problems may likewise occur in cases of forming a pattern for a print electronic device, for example, a case where a material is functional liquid, not ink or a case where a substrate is a glass substrate or a plastic film, not paper.

For example, in a functional material fixation method or a functional material fixation apparatus which is disclosed in Patent Document 2, droplets including functional material are discharged onto a film and then are irradiated with laser light, thereby evaporating some of a solvent in order to increase precision of fixation position of the functional material on the film.

[Patent Document 1] JP-A-2002-015866

[Patent Document 2] JP-A-2005-095849

However, when a figure is drawn by the inkjet method, the problem that the reach position of the droplets in ink is deviated from the target point due to external disturbances such as an air stream, static electricity and the like is unavoidable in the inkjet method and is difficult to be overcome by the method and apparatus disclosed in Patent Document 2.

### SUMMARY

It is an object of the invention to provide a pattern forming apparatus and a pattern forming method, which are capable of easily forming a smooth and indefectible pattern at a desired position while flexibly coping with small quantity batch production, a device manufactured using the apparatus and method, and an electronic equipment having the device.

According to an aspect, there is provided a pattern forming apparatus for forming a pattern by immobilizing a liquid material applied on a substrate using laser light, including: a liquid material application mechanism which has an opening for applying the liquid material on the substrate; and a laser processing mechanism including an irradiation section for irradiating the liquid material applied on the substrate with the laser light for immobilizing the liquid material. The laser processing mechanism is integrated with the liquid material application mechanism.

With the pattern forming apparatus of the present invention, it is further ease to precisely apply the liquid material at an intended position on the substrate as compared to pattern formation by the inkjet method. In addition, it is also ease to form a smooth and indefectible pattern.

In the meantime, like pattern formation by the inkjet method, since it is possible to control the relative position relation between the opening and the substrate based on electronic data corresponding to a pattern to be formed, it is ease to flexibly cope with small quantity batch production.

Accordingly, with the pattern forming apparatus and method of the present invention, it is ease to form a smooth and indefectible pattern at a desired position on the substrate while flexibly coping with small quantity batch production.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view showing a pattern forming apparatus according to Embodiment 1;

FIGS. 2A to 2C are views for explaining a representative dimension of an opening in the pattern forming apparatus;

FIGS. 3A to 3C are views for explaining a process at an application ending port of liquid material by the pattern forming apparatus;

FIGS. 4A to 4D are views for explaining an irradiation pattern of laser light in the pattern forming apparatus;

FIG. 5 is a view for explaining a relation between an application width of liquid material and a beam spot in a pattern forming apparatus according to Embodiment 2;

FIG. 6 is a view for explaining a relation between an application width of liquid material and a beam spot in a pattern forming apparatus according to Embodiment 3;

FIG. 7 is a perspective view showing a pattern forming apparatus according to Embodiment 4;

FIG. 8 is a view for explaining a pattern in which material composition is continuously changed;

FIG. 9 is a perspective view showing a pattern forming apparatus according to Embodiment 5;

FIG. 10 is a perspective view showing a pattern forming apparatus according to Embodiment 6;

FIG. 11 is a perspective view showing a pattern forming apparatus according to Embodiment 7;

FIGS. 12A and 12B are views for explaining laser light having a uniform energy distribution in a beam spot;

FIG. 13 is a process diagram showing a process of manufacturing a metal wiring substrate according to Embodiment 8 of the present invention;

FIG. 14 is a view showing an example of a process order of a method of forming a metal wiring substrate according to Embodiment 8 of the present invention;

FIG. 15 is a view showing an example of a process order of a method of forming a metal wiring substrate according to Embodiment 8 of the present invention;

FIG. 16 is a view showing an example of a process order of a method of forming a metal wiring substrate according to Embodiment 8 of the present invention;

FIG. 17 is a view showing an example of a process order of a method of forming a metal wiring substrate according to Embodiment 8 of the present invention;

FIG. 18 is a view showing an example of a process order of a method of forming a metal wiring substrate according to Embodiment 8 of the present invention;

FIG. 19 is a view showing an example of a process order of a method of forming a metal wiring substrate according to Embodiment 8 of the present invention;

FIG. 20 is a view showing a wiring pattern of a test sample according to Embodiment 8 of the present invention;

FIG. 21 is a view showing a general configuration of a laser ray irradiation scan apparatus according to Embodiment 9 of the present invention; and

FIG. 22 is a view showing a general configuration of an ultraviolet ray irradiation apparatus according to Embodiment 10 of the present invention.

### DETAILED DESCRIPTION

Hereinafter, embodiments of the present invention will be described in detail with reference to the drawings. However, the present invention is not limited to the following embodiments.

### Embodiment 1

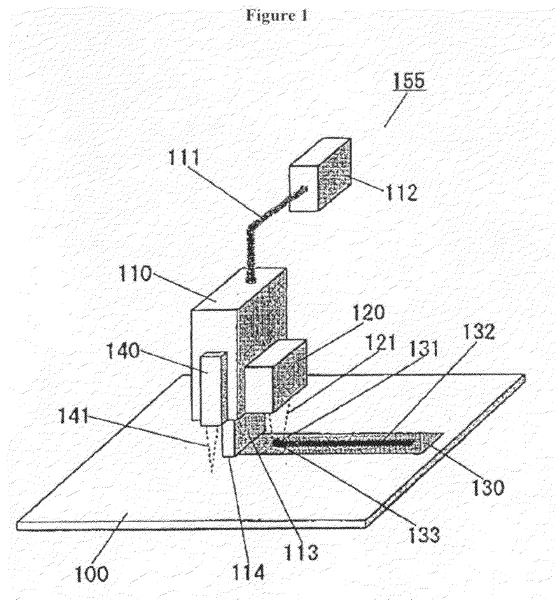

FIGS. 1 to 4D are views for illustrating Embodiment 1 of the present invention. FIG. 1 is a perspective view showing a pattern forming apparatus according to Embodiment 1. In FIG. 1, reference numeral 100 denotes a substrate, reference numeral 110 denotes a liquid material application mechanism, reference numeral 111 denotes a transporting pipe for transporting liquid material to the liquid material application mechanism 110, reference numeral 112 denotes a liquid material supplying source having a tank and a pump for storage and supply of liquid material, reference numeral 113 denotes a liquid material supplying section in the liquid material application mechanism 110, reference numeral 114 denotes an opening through which liquid material in the liquid material supplying section 113 is discharged, reference numeral 120 denotes a laser processing mechanism, reference numeral 121 denotes laser light, reference numeral 130 denotes liquid material, reference numeral 131 denotes an irradiation target point of the laser light 121, reference numeral 132 denotes liquid material immobilized by the laser light 121, reference numeral 133 denotes a beam spot of the laser light 121, reference numeral 140 denotes an opening position measurement mechanism, reference numeral 141 denotes laser light for opening position measurement, and reference numeral 155 denotes a pattern forming apparatus.

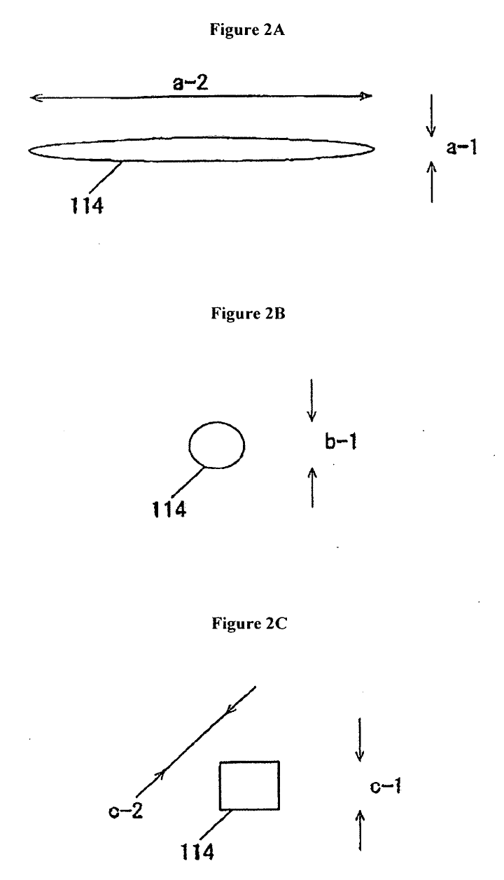

FIGS. 2A to 2C are views for explaining representative dimensions of the opening 114. FIG. 2A is a view for explaining representative dimensions of the opening 114 having an elliptical shape, in which the minimum representative dimension in the opening 114 is represented by a-1 and the maximum representative dimension in the opening 114 is represented by a-2. FIG. 2B is a view for explaining representative dimensions of the opening 114 having a circular shape, in which both of the minimum representative dimension and the maximum representative dimension in the opening 114 are represented by b-1. FIG. 2C is a view for explaining representative dimensions of the opening 114 having a square shape, in which the minimum representative dimension in the opening 114 is represented by c-1 and the maximum representative dimension in the opening 114 is represented by c-2.

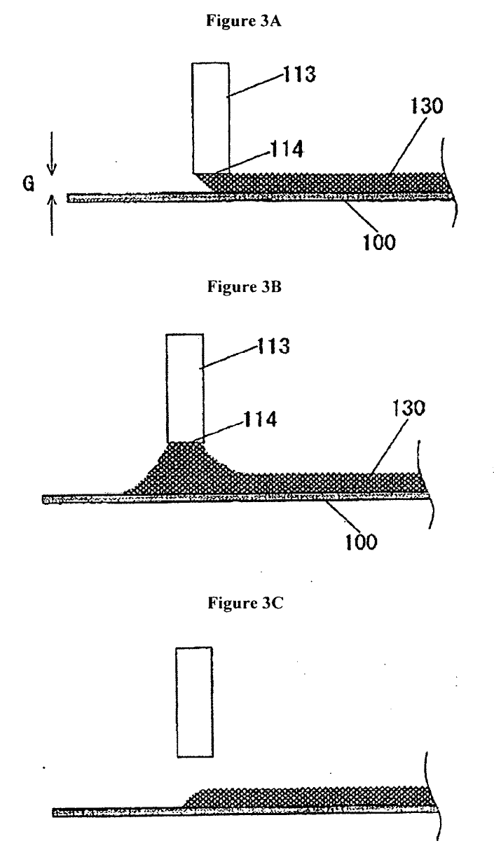

FIGS. 3A to 3C are views for explaining a process at an application ending port of liquid material by the pattern forming apparatus. FIG. 3A is a view for explaining a normal state in which the liquid material 130 is applied, FIG. 3B is a view for explaining a state in which the opening 114 is moved upward above the substrate 100 while performing or stopping discharge of the liquid material 130 at an application ending port, and FIG. 3C is a view for explaining a state in which the opening 114 is moved upward above the substrate 100 after or while absorbing the liquid material 130 at the application ending port. In FIG. 3A, G represents a gap between the opening 114 and the substrate 100.

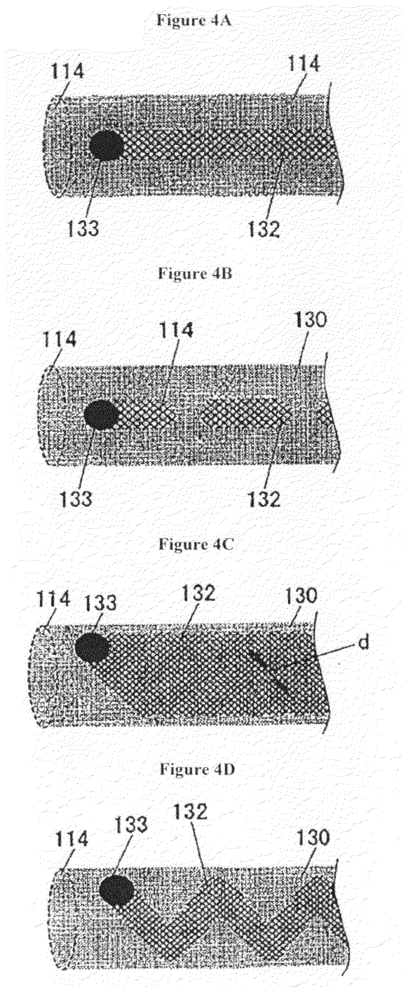

FIGS. 4A to 4D are views for explaining an irradiation pattern of the laser light 121 (see FIG. 1), that is, a moving locus of the beam spot 133. FIG. 4A shows a moving locus of the beam spot 133 in case of continuous irradiation of the laser light 121 while linearly moving the laser processing mechanism 120 (see FIG. 1), FIG. 4B shows a moving locus of the beam spot 133 in case of intermittent irradiation of the laser light 121 while linearly moving the laser processing mechanism 120, and FIGS. 4C and 4D show a moving locus of the beam spot 133 in case of scanning of the laser light 121 while linearly moving the laser processing mechanism 120. In the example shown in FIG. 4C, the laser light 121 is scanned in a direction d intersecting the linear moving direction of the laser processing mechanism 120, and in the example shown in FIG. 4D, the laser light 121 is scanned in a zigzag fashion along the linear moving direction of the laser processing mechanism 120.

In addition to the mechanisms shown in FIG. 1, the pattern forming apparatus 155 (see FIG. 1) related to this embodiment includes a housing (not shown), a movable stage (not shown), and a controller (not shown) for operating all the mechanisms in cooperation. The controller is implemented with a computer system which can be operated by programs, for example.

Now, the substrate 100 and the pattern forming apparatus 155 shown in FIG. 1 will be described in detail. The substrate 100 is a transparent flat plate made of glass such as borosilicate glass and having its surface polished as a mirror surface. Of course, the substrate 100 is not limited to the glass substrate but may be a ceramic substrate or a plastic substrate and does not need to have a flat surface. That is, any substrate may be used as long as it is not melted or significantly deteriorated by irradiation of the laser light 121 for immobilization of the liquid material 130. Also, the substrate 100 may be mechanically rigid or flexible. In this embodiment, the substrate 100 has a planar square shape having one side of 100 mm and thickness of 0.7 mm, The substrate 100 is fixed on the movable stage (not shown) and a relative position with the opening 114 can be changed by moving the movable stage, thereby making it possible to form a pattern at any position on the substrate 100 with high degree of freedom.

The movable stage serves as a moving mechanism to change the relative position of the substrate 100 with the opening 114. The operation of the movable stage is controlled by the above-mentioned controller.

In the meantime, the pattern forming apparatus 155 includes the liquid material application mechanism 110, the transporting pipe 111, the liquid material supplying source 112, the laser processing mechanism 120 and the opening position measurement mechanism 140. Although the liquid material application mechanism 110 is fixed to the housing (not shown), since the position of the substrate 100 is changed by moving the movable state, as described above, it is possible to change the relative position of the substrate 100 with the opening 114 in spite of fixation of the liquid material application mechanism 110. The liquid material application mechanism 110 is connected to the liquid material supplying source 112 via the transporting pipe 111. The liquid material 130 is supplied from the liquid material supplying source 112 to the liquid material application mechanism 110 via the transporting pipe 111, is passed through the liquid material supplying section 113, and then is applied on the substrate 100 through the opening 114.

The liquid material supplying source 112 includes, for example, a tank for storing the liquid material 130 and a squeeze pump for transporting the liquid material stored in the tank to the outside. The tank and the squeeze pump may be integrated. For example, the liquid material supplying source 112 may be a syringe pump for transporting liquid to the outside by changing a volume of its tank in which the liquid is stored. Alternatively, the liquid material supplying source 112 may be configured such that the liquid material is transported by gravity by simply adjusting a height relation between the tank and the liquid material application mechanism without having a mechanism corresponding to the pump. When the liquid material supplying source 112 includes the pump, it is preferable that the pump can send the liquid material 130 to the liquid material application mechanism 110 and can absorb the liquid material 130 back. The discharge/absorption of the liquid material can be easily realized by properly selecting a type of pump. For example, the use of the squeeze pump allows both of the discharge/absorption of the liquid material by normal rotation/reverse rotation of the pump. The operation of the pump is controlled by the above-mentioned controller (not shown), for example.

In the pattern forming apparatus 155 shown in FIG. 11 although the opening 114 of the liquid material application mechanism 110 is disposed above the substrate 100, the positional relation therebetween is not limited to this. For example, it may be configured that the substrate 100 is disposed above the opening 114 and the liquid material 130 is applied on the substrate 100 through the opening 114 below the substrate 100 or it may be configured that the substrate 100 is vertically disposed and the liquid material 130 is applied on the substrate 100 through the opening 114 from the lateral side of the substrate 100.

In this embodiment, the minimum representative dimension of the opening 114 is 500 μm. The minimum representative dimension refers to the minimum line width made by a locus when the opening 114 is moved in a plane direction of the substrate 100. Also, in this embodiment, the maximum representative dimension of the opening 114 is 2 mm. Like the minimum representative dimension, the maximum representative dimension refers to the maximum line width made by a locus when the opening 114 is moved in a plane direction of the substrate 100.

Now, the minimum and maximum representative dimensions will be further described in detail with reference to FIGS. 2A to 2C. FIG. 2A shows an example of the opening 114 having an elliptical section shape, which is employed in this embodiment. Likewise, FIG. 2B shows an example of the opening 114 having a circular section shape and FIG. 2C shows an example of the opening 114 having a square section shape.

In FIG. 2A, the minimum representative dimension is represented by a-1 and the maximum representative dimension is represented by a-2. Likewise, b-1 in FIGS. 2B and c-1 in FIG. 2C represent the minimum representative dimension, and b-2 in FIGS. 2B and c-2 in FIG. 2C represent the maximum representative dimension. Of course, the section shape of the opening 114 is not limited to this but may be any shape. For example, a portion of the section may be cut, that is, like a slit by two plates, the circumference of the opening may not be connected by one.

In this manner, as long as the liquid material 130 can be substantially applied on the substrate 100, an opening having any shape can be used as the opening 114. For the section shape of the opening 114 having high degree of freedom, the minimum and maximum representative dimensions may be defined as follows. That is, the minimum representative dimension may be defined by the smallest value of gaps formed by two parallel lines between which the section shape of the opening 114 is interposed in all directions in a plane including the section. The maximum representative dimension may be defined by a diameter of the minimum circle in which the section shape of the opening 114 is contained.

Here, the minimum representative dimension of the opening 114 is less than 500 μm, for example. This value is a preferable value required to configure the opening 114 which is capable of sufficiently controlling the amount of discharge of the liquid material 130 having various viscosities. If this value is more than 500 μm, it is difficult to control the amount of discharge when liquid material having viscosity of several cps (several mPa·s) is used in many solutions. That is, as shown in FIG. 1, when the liquid material 130 having low viscosity is applied on the substrate 100, if the opening 114 is too large, there is a possibility that the liquid material 130 in the liquid material supplying section 113 falls down on the substrate 100 from the opening 114 by its own weight or is discharged by an unintended amount even if the liquid material supplying source 112 is stopped.

This may be seen from an opening having a diameter of several cm as an extreme example. With such an opening, it is not possible to stay the liquid material 130 in the liquid material supplying section 113 only with a surface tension even if the liquid material supplying source 112 is stopped. Although several cm is extreme, as the minimum representative dimension of the opening 114 becomes large, it is natural that controllability becomes worse particularly when the liquid material 130 having low viscosity is dealt with. The present inventor(s) has carefully reviewed and found that it is possible to maintain good controllability of the liquid material when the minimum representative dimension of the opening 114 is less than 500 μm.

The maximum representative dimension of the opening 114 is not particularly limited. This is because the maximum representative dimension has a slit shape or a bent-slit shape no matter how small it may be since the minimum representative dimension is less than 500 μm. When the opening 114 has a slit shape, since it is expected that even the liquid material 130 having low viscosity can be self-maintained by a sufficient surface tension, it is possible to maintain good controllability.

Referring to FIG. 1 again, detailed configuration of the pattern forming apparatus 155 of Embodiment 1 continues to be described.

Reference numeral 120 denotes the laser processing mechanism 120 including a laser light source (not shown), a light guide section including a prism, a lens, a mirror, an optical fiber and so on, and an irradiation section including optical elements such as a lens to form the beam spot 133 on the irradiation target point 131 on the substrate 100.

Although in this embodiment a semiconductor laser having an emission peak wavelength of 670 nm is used as the laser light source, any suitable laser light source may be used without any limitation. As will be described later, the liquid material 130 has a wavelength range very suitable for laser processing. When such liquid material 130 is used, by selecting a laser light source that emits the laser light 121 whose oscillation wavelength is within the suitable wavelength range, it is possible to increase process efficiency or process a particular one of components contained in the liquid material 130 as the case may be. In addition, even when the liquid material 130 does not have the above suitable wavelength range, since light having a shorter wavelength can be generally condensed on a smaller area, as a property of the laser light 121, which may result in a smaller beam spot 133, it goes without saying that it is possible to draw a fine pattern by using a laser light source having a shorter oscillation wavelength.

Like the wavelength, power of the laser light 121 has to be properly selected to meet the property of the liquid material 130 used. In this embodiment, a laser light source having light power of 800 mW is used. Here, additionally mentioning about the light source, the light source is not limited to the laser light source as long as it can emit light having a wavelength and light intensity to allow substantial immobilization. For example, a high luminance light emitting diode may be used as an alternative of the laser light source. In addition, for light having a very short wavelength range making an apparatus scale too large in the laser light source, a heavy hydrogen lamp may be used an alternative light source.

Since the semiconductor laser used in this embodiment has large spread of a light flux from an emission point although it is the laser light source, the light guide section (not shown) constitutes a collimate optical system using a plurality of prisms and lenses in order to make the light flux parallel. Further, a light intensity distribution (beam profile) in a bean section gives light having a concentric circle shape, that is, a Gaussian beam. In addition, the irradiation section in this embodiment is constituted by a convex lens to condense the laser light propagating along the light guide section on the irradiation target point 131.

The irradiation target point 131 is a position representing an irradiation center point of the laser light 121 shaped as the above-mentioned Gaussian beam. An energy distribution within an irradiation range of the laser light 121 has a concentric circle shape centered at the irradiation target point 131.

In addition, the above-mentioned beam spot 133 shows a range within which the liquid material 130 is substantially immobilized. As described above, since the laser light 121 is the Gaussian beam, the light intensity in the beam section becomes lowered as it becomes far away from the center point. Accordingly, when it is distant above some extent from the center point, there occurs an energy region less than a threshold value to mobilize the liquid material 130. The irradiation range of the laser light 121 is different from a range within which the liquid material 130 is immobilized. Accordingly, in the present invention, a range within which a laser process is substantially carried out, that is, a range within the liquid material is substantially immobilized, is taken as the beam spot 133. Like other mechanisms, the operation of the laser processing mechanism 120 is controlled by the controller (not shown).

Next, reference numeral 140 denotes the opening position measurement mechanism. The opening position measurement mechanism 140 measures a gap between the substrate 100 and the opening 114 and includes a laser light source, an optical system, a light receiving device (all not shown), etc. in this embodiment. The opening position measurement mechanism 140 measures a gap G (see FIG. 3A) between the substrate 100 and the opening 114 according to a laser interferometry. Reference numeral 141 denotes the laser light for measurement of opening position. Of course, since the essential function of the opening position measurement mechanism 140 is the measurement of the gap G, a measuring method is not limited to a method using the laser light. For example, the measuring method may include various methods such as measurement using an ultrasonic wave, mechanical contact of a detection arm with the substrate 100, analysis on an image taken near the opening 114, etc.

The opening position measurement mechanism 140 always measures the gap G during a period of time when the pattern forming apparatus 155 operates, and a result of the measurement is sent to the controller (not shown). By referring to measurement data and a preset program, the controller controls vertical movement of the movable stage (not shown) to maintain the gap G at a predetermined value. The movable stage functions as an opening position control mechanism to control a value of the gap G.

Here, the opening position measurement mechanism 140 is configured to move the measurement position if necessary. In addition, by mounting a plurality of opening position measurement mechanisms 140 on the pattern forming apparatus 155, it is possible to cope with a complicated substrate shape.

Now, a need to measure the gap G will be described with reference to FIGS. 3A to 3C.

First, if the substrate 100 is substantially flat, it is important to maintain the gap G constant in order to uniformly apply the liquid material 130 on this substrate 100. If the gap G is widened, the liquid material 130 is pulled up to the opening 114 by a surface tension, which may result in decrease of a contact area with the substrate 100. In an extreme case, the liquid material 130 may become far way from the substrate 100 such that an application state is discontinuous. On the contrary, if the gap G is narrowed, the liquid material 130 is pressed against the substrate 100, which may result in increase of the contact area with the substrate 100. In an extreme case, the opening 114 may contact the substrate 100, thereby making discharge of the liquid material 130 impossible or doing damage to the substrate 100. In consideration of this point, in a normal application state of the liquid material 130 shown in FIG. 3A, it is preferable to maintain the gap G between the substrate 100 and the opening 114 constant, and, to this end, there is a need to measure the gap G.

Even when the substrate 100 has unevenness, it is important to maintain the gap G constant for the above-mentioned reason in order to achieve uniform application of the liquid material 130, and, to this end, there is a need to measure the gap G and control the movable stage such that the opening 114 follows the unevenness of the substrate 100.

The above description is about the case where the liquid material 130 is normally applied on the substrate 100. However, there may be some cases where a termination process shown in FIG. 3C is performed when the gap G is intentionally changed or an application with a pattern of periodical change in film thickness is carried out by changing the gap G periodically.

In the pattern forming apparatus 155 of this embodiment, although the movable stage (not shown) is used to move the substrate in order to change the relative position of the substrate 100 with the opening 114, a movable means for changing the relative position is not limited to this. For example, the substrate 100 may be fixed, and, instead, the liquid material application mechanism 110, the laser processing mechanism 120 and so on may be fixed to a movable mechanism. The movable mechanism may include, for example, a 3-axis actuator, a robot arm having a plurality of joints, etc.

Hitherto, the detailed configuration of the pattern forming apparatus 155 of this embodiment has been described. Subsequently, the operation of the pattern forming apparatus 155 to form a pattern will be described in detail. Prior to this description, meanings of the liquid material and immobilization in the present invention will be first described.

In the present invention, the liquid material refers to a fluid having substantial mobility and having a viscosity range within which the fluid can be applied on the substrate from the opening. Composition of the liquid material is not particularly limited. However, in this embodiment, a formed pattern is assumed to have any electronic function, and accordingly, the liquid material in the present invention is one of a conductor, a semiconductor and an insulator after it is at least immobilized.

In Embodiment 1, a dispersion solution made by silver (Ag) fine particles are dispersed in an organic solvent is used as the liquid material. For example, this dispersion solution may be NPS-J (product name) available from Harima Chemicals, Inc. A metal colloidal dispersion solution or a solution containing metal ions may be used as the same liquid material. Moreover, the present invention may be practiced using a liquid material containing ceramics such as oxides or nitrides or a liquid material containing an organic electronic functional material or its precursor which has been variously proposed.

Next, the immobilization in the present invention will be described. The immobilization in the present invention refers to change of the original liquid material 130 into a different state, or change of the original liquid material 130 into a state where components in the liquid material 130 are not re-dissolved in the solvent constituting the liquid material 130 according to a physical and chemical change occurring in the liquid material 130 itself or at least one component contained in the liquid material 130 when the laser processing mechanism 120 irradiates the liquid material 130 with the laser light 121 with the liquid material 130 applied on the substrate 10. The immobilization is the concept to be distinguished from a simple drying for solution.

In other words, when a solute is immobilized by heating the liquid material 130 as a solution to evaporate and remove a solvent by means of irradiation of the laser light 121 or using any heating unit, although the immobilized solute is re-dissolved in the solvent at least constituting the solution, the immobilization in the present invention is the concept to be distinguished from such immobilization.

Examples of the above-mentioned physical change may include melting, fusing, penetration, sintering, etc., and examples of the above-mentioned chemical change may include cross-linking, polymerization, decomposition, oxidation, reduction, etc.

In Embodiment 1, the liquid material 130 containing silver ultra fine particles is instantaneously heated by the irradiation of the laser light 121 to evaporate the solvent and fuse the silver ultra fine particles together to be passivated, which results in immobilization by the physical change.

Of course, other than the immobilization by the fusing, there may also be a method for immobilizing a mixture of the liquid material 130 containing the silver ultra fine particles, styrene monomer, a hydrogen peroxide-based polymerization initiator as a reaction initiator, a cross-linking agent, etc, at proper ratios or a mixture of the liquid material 130, epoxy monomer and an acid polymerization initiator by irradiating this mixture with the laser light 121. In this case, when the liquid material 130 is heated by the irradiation of the laser light 121, the polymerization initiator mixed in the liquid material 130 is decomposed, and a polymerization reaction is initiated by radicals produced by the decomposition, which results in polymerization of the monomer and hence the immobilization of the liquid material 130. At this time, since the irradiation of the laser light 121 is for heating the liquid material 130 to decompose the polymerization initiator and initiate the polymerization reaction, there is no need of large laser power required for the immobilization by the fusing.

Although not described in detail, there have been known a number of reaction systems to initiate a chemical reaction in response to light having a particular wavelength, and, with application of such reaction systems, it is ease to realize a selective method for achieving immobilization only with irradiation of the laser light 121 having a particular wavelength. In addition, by simultaneously using a plurality of reaction systems sensitive to light having respective particular wavelengths, it is possible to realize an immobilization process with more complexity and higher degree of freedom. In an example where a resin-based material is mixed in the liquid material containing the silver ultra fine particles, since the silver ultra fine particles are not fused together although the immobilization in the present invention is completed, there is a need to fuse the silver ultra fine particles with a separate process in order to use the silver ultra fine particles as a pattern of a conductor.

There may be also a case where a monomer material polymerized by irradiation of the laser light 121 is used as a functional pattern. This is a case of forming an insulating film using an insulating property of plastics known in common or a case of forming a pattern of a polymeric material having electronic functionality. As one example, there is PPV (polyphenylenevinylene) well known as an emissive polymeric material. PPV itself has passivity state in a polymeric state and is not easily dissolved in a solvent. However, phenylenevinylene monomers having particular functional groups have been variously studied and proposed, and some of which are available. These monomers are liquefied materials as simple substances and can be applied on the substrate 100 in the pattern forming apparatus 155 of this embodiment. These monomers are heated and polymerized by irradiation of the laser light 121 to form the PPV. As described above, since the PPV is in the passive state, a series of processes is included in the immobilization in the present invention. Light emitting devices and transistors can be constructed using the PPV.

In this manner, by properly selecting the composition of the liquid material 130 used, the immobilization in the present invention can be achieved by inducing a physical change such as fusing when the liquid material containing, for example, the silver ultra fine particles is used, or by inducing a chemical reaction (chemical change) such as when a styrene monomer, a hydrogen peroxide-based polymerization initiator, a cross-linking agent, etc. are mixed with the liquid material 130 containing silver ultra fine particles at a proper ratio or when a PPV monomer is used.

Next, a method of sequentially processing and immobilizing the liquid material applied on the substrate by means of laser light according to the present invention will be described.

The process by laser light in the present invention means that the liquid material containing a component such as a solvent which does not finally constitute a pattern is immobilized by irradiation of laser light before the liquid material is dried as the solvent is all evaporated. In addition, for other materials, such as the above-mentioned PPV monomer, whose final pattern does not contain a solvent and which still maintain their mobility even with lapse of certain time after application of the liquid material, the process by laser light in the present invention means that the liquid material is immobilized by irradiation of laser light without performing separate processes after the application of the liquid material. Further, even in case where the liquid material is repelled and spreads due to a difference in affinity of the substrate with the liquid material and is unintentionally moved from a state immediately after the application, the process by laser light in the present invention also means that the liquid material is immobilized by irradiation of laser light before the liquid material is moved.

Now, detailed operation of the pattern forming apparatus 155 according to Embodiment 1 of the present invention will be described. First, the substrate 100 is cleaned and is fixed to the movable stage (not shown). In this embodiment, since the substrate 100 is the borosilicate glass substrate, the cleaning is removal of oil and fat, and granular attachments, which is performed in common in a thin film forming process. The cleaning is carried out by using a surfactant, alkaline detergent, an ultrasonic cleaning apparatus, etc. It may be also preferable to clean a surface of the substrate 100 using a plasma processing apparatus. Of course, it goes without saying that a cleaning method has to be properly selected depending on material of the substrate 100 used, etc.

In addition, there may be also a case where the cleaned substrate 100 is subjected to a pre-treatment process. This pretreatment process is for increasing surface roughness by applying a base material or making a surface rough in order to improve characteristics such as smoothness, adhesion and the like.

When the substrate 100 is set on the movable stage, the opening 114 approaches the substrate 100. At this time, the opening position measurement mechanism 140 continuously measures the gap G (see FIG. 3A) between the opening 114 and the substrate 100 and provides data to inform that the gap G is appropriate. Although the movable stage may be manually moved, the controller (not shown) controls the moving of the movable stage in this embodiment. Hereinafter, although not being particularly limited, the controller controls the operation of respective mechanisms in the pattern forming apparatus 155 of this embodiment according to a preset operation program.

The optimal value of the gap G depends on various factors such as the material and surface condition of the substrate 100, the kind of the liquid material 130, the film thickness of the liquid material 130 immediately after being applied, an application speed, an ambient temperature, a substrate temperature, etc. As one example, a value of the gap G is 0.2 mm in this embodiment.

After the gap G is optimized, the liquid material supplying source 112 operates to send the liquid material 130 to the liquid material application mechanism 110, and the liquid material 130 sent to the liquid material application mechanism 110 is discharged on the substrate 100 through the opening 114. At the same time, the movable stage changes the relative position of the substrate 100 with the opening 114 based on pre-programmed data, and application of the liquid material 130 on the substrate 100 is initiated.

The laser processing mechanism 120 irradiates the applied liquid material 130 with the laser light 121, and the liquid material 130 is sequentially processed and immobilized by the laser light 121.

As described above, in this embodiment, the opening 114 has an elliptical shape, its minimum representative dimension is 500 μm and its maximum representative dimension is 2 mm. Here, pattern formation when the pattern forming apparatus 155 is controlled so that an application plane as a locus drawn by the opening 114 has a band-like shape having width of 2 mm, that is, the liquid material 130 is applied with the maximum representative dimension, will be described. For the purpose of simplicity of description, a further description will be given by applying the liquid material 130 on the substrate 100 in a linear fashion. Needless to say, by properly controlling the operation of the movable stage, it is possible to form a complex pattern having bent lines or achieve application of the entire surface.

When the liquid material 130 is applied on the substrate 100, the laser processing mechanism 120 irradiates the irradiation target point 131 on the liquid material 130 with the laser light 121. In this embodiment, the relative position of the irradiation target point 131 with the opening 114 is fixed. When the liquid material 130 within the beam spot 133 is heated by the irradiation of the laser light 121, the solvent is volatilized and the dispersed silver ultra fine particles are fused together to be passivated, thereby progressing the immobilization in the present invention.

At this time, an area and shape of the beam spot 133 depends on various factors such as the intensity and energy distribution (light intensity distribution; beam profile) of the laser light 121, the degree of condensation of the laser light 121, the kind of the liquid material 130, the film thickness of the liquid material 130, the application speed of the liquid material 130, the material of the substrate 100, etc., and the area and shape of the beam spot 133 has to be optimized whenever a pattern is formed. In this embodiment, the beam spot 133 has a circular shape centered at the irradiation target point 131 and has the diameter of 0.1 mm. Accordingly, an immobilization range becomes narrower than an application range. This is close to the state shown in FIG. 1.

While the relative position of the substrate 100 with the opening 114 is linearly changed by the operation of the movable stage, the opening position measurement mechanism 140 continuously measures the gap G (see FIG. 3A) between the opening 114 and the substrate 100. Since the operation of the movable stage is controlled based on a result of the measurement such that the application is progressed with the gap G maintained constant, for example even when the substrate 100 is unexpectedly bent, the movable stage is moved to follow such bend, and accordingly, the film thickness of the applied liquid material 130 becomes continuous and stable. In addition a pattern formed by the sequential immobilization is smooth and has no defect.

Now, an operation when the linear smooth and indefectible pattern is formed in this manner and the positional relation between the substrate 100 and the opening 114 reaches a pre-programmed application ending point will be described with reference to FIGS. 3A to 3C.

In this embodiment, since a linear pattern is simply formed, the opening 114, which finished the application, becomes far away from the substrate 100 at the application ending point, completing the pattern formation.

FIG. 3A shows a state under the application as described above and in which the application and immobilization are stably carried out. In the state shown in FIG. 3A, the predetermined amount of liquid material 130 is sent from the liquid material supplying source 112 to the liquid material application mechanism 110 (see FIG. 1) via the transporting pipe 111, and the liquid material 130 sent to the liquid material application mechanism 110 is continuously discharged from the liquid material supplying section 113 onto the substrate 100 through the opening 114. When the movable stage is moved such that the opening 114 becomes far away from the substrate 100 at the application ending point while continuing the discharging operation, excessive liquid material 130 is discharged at the ending point as shown in FIG. 3B such that the film thickness of the liquid material 130 near the ending point increases. At this time, the movable stage may be moved such that the opening 114 becomes far away from the substrate 100 after the liquid material supplying source 112 is stopped. However, even in this case, there may be a case where excessive liquid material 130 is drawn out from the opening 114 due to a surface tension depending on the kind of the liquid material 130, which may result in increase of the film thickness of the liquid material 130 near the ending point.

In order to avoid ununiformity of the film thickness near the ending point, the liquid material supplying source 112 may be moved toward an absorption side to cancel out a force (surface tension) to draw the liquid material 130 out of the opening 114. Of course, since an absorption force and a timing at that time are related to various factors such as the kind of the liquid material 130, the kind of the substrate 100, etc., it goes without saying that there is a need to set the optimal values for the absorption force and the timing. By carrying out a proper absorption operation at the application ending point of the liquid material 130, as shown in FIG. 3C, it is possible to make the film thickness of the liquid material 130 at the application ending point nearly equal to that of the liquid material 130 at portions other than the application ending point, which may result in smoothness and uniformity of the pattern obtained by the immobilization of the liquid material 130.

In the above description about the pattern formation, although the irradiated laser light for the laser process for the immobilization has been illustrated with time-continuous light, intermittent light may be used to form the pattern.

Now, an example of forming a pattern using the intermittent light will be described in detail with reference to FIGS. 4A to 4D. FIG. 4A shows a case where irradiated laser light is continuous light and shows a pattern 132a formed when the beam spot 133 is narrower than an application width of the liquid material 130.

When the irradiated laser light is the continuous light, it is possible to form a discontinuous pattern 132 while continuously applying the liquid material 130, as shown in FIG. 4B. The irradiation of the intermittent laser light can be easily realized by simply turning on/off the laser light source or controlling open/close of a shutter disposed in the course of an optical path.

As an alternative example of intermittent irradiation of the laser light, there may be a case where the liquid material 130 applied on the substrate 100 is scanned with the laser light. By scanning the liquid material 130 with the laser light, it is possible to form a continuous pattern or draw a complex pattern within an application range of the liquid material 130 using the intermittent light. This is illustrated in FIGS. 4C and 4D. In FIG. 4C, the liquid material 130 is scanned with the laser light shortly and intermittently in a direction indicated by an arrow d and with a predetermined period. At this time, since individual irradiation patterns of the intermittent light are overlapped with each other, the pattern 132 formed finally becomes continuous as indicated by a solid line in FIG. 4C. In addition, it is possible to form a complex pattern 132 as shown in FIG. 4D. In order to obtain such a complex pattern 132, while carrying out the scanning as shown in FIG. 4D, the laser light source may be intentionally, not periodically, turned on/off to draw a certain pattern.

For the scanning of the laser light, within the irradiation section of the laser processing mechanism 120 may be provided a rotating reflection mirror (polygonal mirror or the like) and a theta lens (fθ lens) for forming the beam spot 133 on the irradiation target point 131 (see FIG. 1) on the substrate 100. Although detailed description of such a so-called scan optical system is omitted, this technique is so common as to be used in commodities such as laser printers and so on and can be introduced with ease.

In addition, as another example of using the intermittent light, immobilization using a laser light source that emits extremely short pulse light, which is called a picosecond laser or a femtosecond laser, is a portion of the present invention. Since such extremely short pulse light is emitted with a very short period, it can be actually treated as continuous light in comparison to a relatively slow change of the relative position of the opening 114 with the substrate 100.

In that case, a difference between the extremely short pulse light and the continuous light is in energy density. In the present invention, when the extremely short pulse light is used to form the pattern, the liquid material 130 is immobilized by irradiating the liquid material 130 with the laser light having very high energy density in a short time, while, when the continuous light is used to form the pattern, the liquid material 130 is immobilized by irradiating the liquid material 130 with the laser light having relatively low energy density.

When the liquid material 130 is immobilized using the laser light having relatively low energy density, since it may take a long time to complete the immobilization as compared to when the liquid material 130 is immobilized using the laser light having high energy density, the substrate 100 may be wastefully heated by energy dissipated through the liquid material 130. For example, if the substrate 100 is susceptible to heat, the substrate 100 may be damaged by heating. On the contrary, when the liquid material 130 is immobilized using the extremely short pulse light having very high energy density, the immobilization of the liquid material 130 is completed in a very short time with the irradiated laser light. At this time, it is possible to select a condition that most of irradiation energy is consumed for the immobilization of the liquid material 130 with little heat dissipated into the substrate 100. In this case, it is possible to form the pattern with no problem even when the substrate 100 is susceptible to heat. This is superiority of the extremely short pulse light.

In this manner, when the discontinuous pattern is formed using the intermittent light as well as the continuous light as the laser light 121, when the complex pattern is formed through the scan of the laser light 121, and when the pattern is used using the extremely short pulse light, there is no essential distinction as to the immobilization of the liquid material 130 within the beam spot 133 and the respective patterns are smooth and have no defect.

In addition, it is preferable that the pattern forming apparatus has a plurality of laser processing mechanisms for one liquid material application mechanism. In this embodiment, since the application width of the liquid material 130 is 2 mm and the diameter of the beam spot 133 is 0.1 mm, by using the plurality of laser processing mechanisms 120 having the same configuration, for example, two laser processing mechanisms 120 simultaneously, it is possible to simultaneously form two immobilized patterns each having width of 0.1 mm for the application width of 2 mm of the liquid material 130. This means that it is possible to simultaneously form two parallel patterns even using simple laser processing mechanisms 120 with fixed irradiation direction of the laser light 121 without scanning of the laser light.

Of course, it goes without saying that more complex patterns may be formed with differently shaped beam spots 133 of the laser light 121 in respective laser processing mechanisms 120, or by taking irradiation sections in the respective laser processing mechanisms 120 as scan optical systems, or with different oscillation wavelengths of laser light sources in the respective laser processing mechanisms 120, or with different power of respective laser light sources.

Moreover, for example, when two laser processing mechanisms 120 having two laser light sources having different oscillation wavelengths perform laser processes sequentially with laser light emitted from these laser light sources, it is preferable to form one pattern. For example, this is a case where a first laser processing mechanism 120 having a laser light source having a first oscillation wavelength immobilizes some of components of the liquid material 130, while a second laser processing mechanism 120 having a laser light source having a second oscillation wavelength continues to immobilize other portions of the liquid material 130, including at least the portion immobilized by the first laser processing mechanism 120, In either case, the formed pattern is smooth and has no defect.

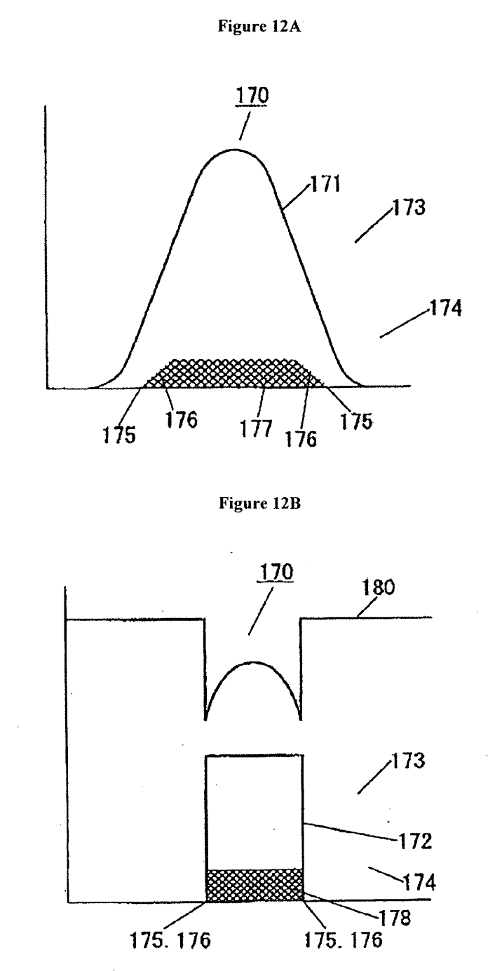

Although in this embodiment the laser light 121 has been illustrated with the Gaussian beam, the laser light 121 may have an energy distribution (beam profile) as will be described with reference to FIGS. 12A and 12B.

FIG. 12A shows an example of laser light having a Gaussian energy distribution and FIG. 12B shows an example of laser light having a shaped energy distribution. In graphs of these figures, a horizontal axis represents a position on the substrate 100, a vertical axis represents a relative value of laser light energy, and reference numeral 170 denotes a line representing a position of the irradiation target point 131 (see FIG. 1). Reference numeral 171 denotes a line representing an energy distribution in Gaussian laser light (see FIG. 12A), reference numeral 172 denotes a line representing a shaped energy distribution in the laser light (see FIG. 12B), reference numeral 173 denotes a line representing an energy level at which the liquid material 130 (see FIG. 1) is sufficiently immobilized, reference numeral 174 denotes a line representing a lower limit energy level at which the liquid material 130 is immobilized, reference numeral 175 denotes a line representing an end portion of a pattern to be formed, reference numeral 176 denotes a line representing an end portion of a flat region in a pattern to be formed, reference numerals 177 and 178 denote sections of formed patterns, and reference numeral 180 denotes a line representing a light absorption characteristic of an optical filter added to shape a beam profile of laser light.

As described above, the liquid material is immobilized by the irradiated laser light energy and the range within which the liquid material is substantially immobilized is the beam spot in the present invention. As in this embodiment, when the pattern is formed using the laser light having the Gaussian energy distribution, the section 177 of the formed pattern has a trapezoidal shape collapsed from a rectangular shape, as shown in FIG. 12A. This is because the liquid material is not suddenly immobilized from certain threshold energy, but the liquid material is slowly immobilized from a portion exceeding a lower limit of energy required for immobilization. Since liquid material in a region having insufficient energy although exceeding the lower limit of energy required for immobilization, that is, the liquid material applied a region between the end portion 175 of the pattern shown in FIG. 12A and the end portion 176 of the flat region, is not immobilized over its film thickness direction, the liquid material shows a slow change of film thickness. On the contrary, since the center other than the end portion 176 of the flat region, that is, a region at the line 170 side representing the position of the irradiation target point 131, is irradiated with the laser light having energy allowing sufficient immobilization, the applied liquid material is immobilized over its film thickness direction, which results in constant film thickness of the applied liquid material.

In order to avoid the pattern collapse shown in FIG. 12A, the energy distribution (beam profile) in the laser light may be shaped into the energy distribution as indicated by the line 172 in FIG. 12B. To this end, it is preferable that an optical filer having a light absorption characteristic as indicated by the line 180 in FIG. 12B is inserted somewhere in the course of an optical path of laser light in order to intercept a light flux of a halfway region and equalize the energy distribution in the beam spot. Here, in the optical filter having the light absorption characteristic as indicated by the line 180, the upper side of the graph gives higher light absorptance. This optical filter may be replaced with a simple holed plate that passes a light flux of a region having energy allowing sufficient immobilization of the liquid material. However, in this case, an attention is required in order that energy density near the irradiation target point 131, that is, an energy peak value, is not excessive. The irradiation of laser light having excessive energy density may do damage to the substrate, and in an extreme case, may cause evaporation of the applied liquid material, which is a so-called ablation.

When the optical filter having the light absorption characteristic as described above is used, the energy distribution (beam profile) in the laser light has a rectangular shape as indicated by the line 172 in FIG. 12B. That is, the laser light with which the liquid material is irradiated has a uniform energy distribution and has energy sufficient to immobilize the liquid material. As a result, the formed pattern has a rectangular shape having the section 178 as shown in FIG. 12B. Such a section is very effective in forming fine patterns having a very narrow gap therebetween. The formed patterns are smooth and have no defect.

Although in this embodiment the laser light is used to immobilize the liquid material, other suitable methods may be used as long as they can immobilize the liquid material.

### Embodiment 2

Hereinafter, Embodiment 2 of the present invention will be described in detail with reference to FIGS. 1, 2A to 2C and 5. The pattern forming apparatus in Embodiment 2 has the same configuration as that in Embodiment 1, and therefore, detailed explanation of which will be omitted and only portions different from Embodiment 1 will be described in detail.

A difference between the pattern forming apparatus of Embodiment 2 and that of Embodiment 1 is a relation between the representative dimension of the opening 114 and the size of the beam spot 133.

In Embodiment 1, the case where the width of the liquid material 130 applied on the substrate 100 is larger than the beam spot 133 has been illustrated. In Embodiment 2 the shape of the opening 114 is circular as shown in FIG. 2B and its representative dimension is 0.2 mm. Of course, the circular shape of the opening 114 means that the maximum and minimum representative dimensions are equal to each other, that is, 0.2 mm in Embodiment 2.

In Embodiment 2, the shape of the beam spot 133 is circular like Embodiment 1, and its diameter is 0.7 mm. That is, the beam spot 133 representing the energy range of the irradiated laser light 121 within which the liquid material 130 can be substantially immobilized becomes sufficiently larger than the application range of the liquid material 130 in Embodiment 2.

In this embodiment, the movable stage (not shown) is controlled such that the center of a band of liquid material 130 applied from the circular opening 114 coincides with the irradiation target point 131 (see FIG. 1) as the center of the beam spot 133. Accordingly, the beam spot 133 always covers the application range of the applied liquid material 130.

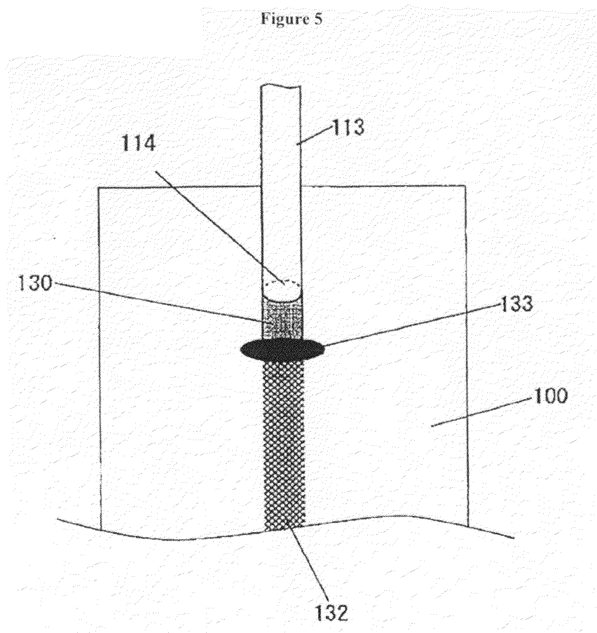

FIG. 5 shows the relation as described above. That is, since the application width of the liquid material 130 applied from the opening 114 is completely covered by the beam spot 133, the entire of applied liquid material is sequentially processed to become immobilized liquid material 132. At this time, the width of the immobilized liquid material 132, the application width of the liquid material 130 and the representative dimension of the opening 114 are equal to each other. That is, in this embodiment, the immobilized liquid material 132 having the width of 0.2 mm is obtained. With this configuration, it is very convenient in that a selection range of combinations of the substrate 100 on which smooth and indefectible patterns can be formed and the liquid material 130 is highly enlarged.

In general, the combination of the substrate 100 and the liquid material 130 has a variety of affinity therebetween depending on use of the formed pattern. In some case, there is a need to form a pattern using aqueous material or oil-based material on a plastic film having a water-repellent surface.

In Embodiment 2, the substrate 100 is a flexible fluorine-based plastic film, which is adhered to a support substrate and then is fixed to the movable stage (not shown). In this embodiment, the liquid material 130 is a gold (Au) colloid dispersion solution and a dispersion medium is water. Immobilization of the gold colloid dispersion solution is accompanied with a physical change in which dispersed gold fine particles are fused and bonded together to be passivated.

However, since a surface of the fluorine-based plastic film is typically water-repellent, it is difficult to uniformly apply aqueous liquid thereon. Accordingly, in case of the combination of the substrate and the liquid material in Embodiment 2, in an attempt to apply the liquid material on the substrate by means of spin coating and then perform a laser process, the application will not be done since the fluorine-based plastic film repels the aqueous liquid material. The aqueous liquid material is swelled up on the fluorine-based plastic film due to its surface tension, and accordingly can not be maintained under a uniformly and widely-applied state. However, when the pattern forming apparatus of the present invention is used, it is possible to form a pattern with high degree of freedom even for the combination of the substrate 100 and the liquid material 130 in which it is difficult to apply the liquid material 130 by means of typical methods and hence to form a pattern.

In this embodiment, the order of process until the liquid material (gold colloid dispersion solution) 130 is applied on the substrate 100 (fluorine-based plastic film) is the same as that in Embodiment 1, and therefore detailed explanation of which will be omitted and detailed description from immediately before the application starts will be given.

Immediately before the application, that is, while the gold colloid dispersion solution is held between the opening 114 and the substrate 100, since a pressure at a discharge side is exerted by action of the liquid material supplying source 112, the gold colloid dispersion solution is pressed against the substrate 100 to spread up to an area equal to the section shape of the opening 114. When the application starts and the gold colloid dispersion solution is applied on the substrate 100, the gold colloid dispersion solution has a spherical shape by its surface tension immediately after that and begins to move in a direction to minimize a contact area with the substrate 100. However, in the pattern forming apparatus of the present invention, since the applied gold colloid dispersion solution is sequentially irradiated with the laser light 121 and its beam spot 133 completely covers the width of the applied gold colloid dispersion solution, the gold colloid dispersion solution can not substantially obtain time required for movement, which results in immobilization of the solution with the application width immediately after the application, that is, with the representative dimension of the opening 114 maintained at 0.2 mm.

That the gold colloid dispersion solution can not substantially obtain time required for movement is a qualitative expression, and proper conditions for realizing this have to be reviewed. In the pattern forming apparatus of the present invention, there is no essential restriction on a relative position relation between the irradiation target point 131 and the opening 114, and, if desired, it is ease to set a gap therebetween to be zero. At any rate, these conditions have to be properly optimized, including other factors described in Embodiment 1.

Hitherto, although the case where the substrate 100 and the liquid material 130 repel each other without being adhered to each other due to low affinity therebetween has been illustrated, the present invention is more effective for a contrary case as will be described below.

For example, instead of the fluorine-based plastic film of the above-described combination, a glass substrate having a titanium oxide-treated surface may be used by way of an example.

Titanium oxide has been known to form a so-called ultra hydrophilic surface having a very high hydrophilic property depending on a film forming method. When aqueous liquid is dropped on such a surface, a contact angle therebetween substantially becomes 0 degree. That is, the dropped aqueous liquid continues to be adhered to and spread over the surface of the substrate.

When such a combination of the substrate 100 and the liquid material (gold colloid dispersion solution) 130 is used, of course, although it is ease to form a pattern even using a conventional method such as spin coat or the like, it is also possible to form a pattern using the pattern forming apparatus of the present invention. In this case, a force is exerted in a direction in which the liquid material 130 is adhered and spreads in the opposite to the previous case from immediately after the application. However, even in this case, the liquid material 130 is immobilized with no time for movement, which results in formation of the pattern having the width of 0.2 mm equal to the representative dimension of the opening 114.

In another case, the present invention is effective for a case where the substrate 100 is made of porous material. That is, if the substrate 100 is porous, when the liquid material 130 is applied on the surface of the substrate 100, there may be a case where the liquid material 130 is repelled depending on the combination of the liquid material 130 and the substrate 100, as described above. Here, especially in case of the combination of the adhered and spread liquid material 130 and the substrate 100, since the liquid material 130 is permeated into the porous substrate, it is difficult to form a pattern using a typical method. However, using the pattern forming apparatus of this embodiment, since the applied liquid material 130 is sequentially processed and immobilized by the laser light 121 before it is adhered and spreads, that is, is permeated, into the porous substrate, it is possible to form the pattern with no problem.

As described above, in Embodiment 2 of the invention, since the beam spot 133 completely covers the application width of the liquid material 130 applied from the opening 114, in various combinations of the substrate 100 and the liquid material 130, it is possible to form a pattern having width specified by the representative dimension of the opening 114. Although in this embodiment the representative dimension of the opening 114, that is, the substantial application width of the liquid material 130, is 0.2 mm, this has to be properly varied depending on a shape of a pattern to be formed. At this time, what needed is only change of the representative dimension of the opening 114 and the size of the beam spot 133, and it is very ease to implement this. Of course, in consideration of industrial applications, although there is a limit to the representative dimension of the opening 114, it is sufficiently practicable to change the representative dimension in a range of several cm to several μm.

In this embodiment, with the pattern forming apparatus as described above, it is possible to obtain smooth and indefectible patterns with high dimension precision and high degree of freedom in various combinations of the substrate 100 and the liquid material 130.

### Embodiment 3

Next, Embodiment 3 of the present invention will be described in detail with reference to FIGS. 1, 2A to 2C and 6. The pattern forming apparatus in Embodiment 3 has the same configuration as that in Embodiment 1, and therefore, detailed explanation of which will be omitted and only portions different from Embodiment 1 will be described in detail. This embodiment is the same as Embodiment 2 in that the used liquid material is the aqueous gold colloid dispersion solution and the substrate is the fluorine-based plastic film adhered to the support substrate, and a series of processes of applying the gold colloid dispersion solution as the liquid material and immobilizing the liquid material is much overlapped with contents described in detail in Embodiment 1 or 2, and therefore portions different from the overlapped contents will be additionally described.

A difference between the pattern forming apparatus of Embodiment 3 and that of Embodiment 1 is the representative dimension of the opening 114 and the size of the beam spot 133.

In Embodiment 1, the case where the width of the liquid material 130 applied on the substrate 100 is larger than the beam spot 133 has been illustrated. Also in Embodiment 3, the relative relation therebetween, that is, the relation that the width of the liquid material 130 applied on the substrate 100 is larger than the beam spot 133, is unchanged. However, while the shape of the opening 114 in Embodiment 1 is elliptical as shown in FIG. 2A, in this embodiment, the shape of the opening 114 is circular as shown in FIG. 2B, like Embodiment 2, and its representative dimension is 0.2 mm like Embodiment. Accordingly, this embodiment is the same as Embodiment 2 in that the maximum and minimum representative dimensions of the opening 114 are equal to each other, that is, 0.2 mm.

In Embodiment 3, the shape of the beam spot 133 is circular like Embodiment 1, and its diameter is 0.01 mm. That is, the beam spot 133 representing the energy range of the irradiated laser light 121 within which the liquid material 130 can be substantially immobilized becomes smaller than the application range of the liquid material 130 in this embodiment.

In this embodiment, the movable stage (not shown) is controlled such that the center of a band of liquid material 130 applied from the circular opening 114 coincides with the irradiation target point 131 as the center of the beam spot 133. Of course, since it is possible to sufficiently form a pattern even if the position of the irradiation target point 131 within the application range of the liquid material 130 is more or less deviated from the center of the band of the liquid material 130, the center coincidence therebetween is not an indispensable condition. However, for the purpose of more simplicity of description, this embodiment employs the same condition as Embodiment 2.

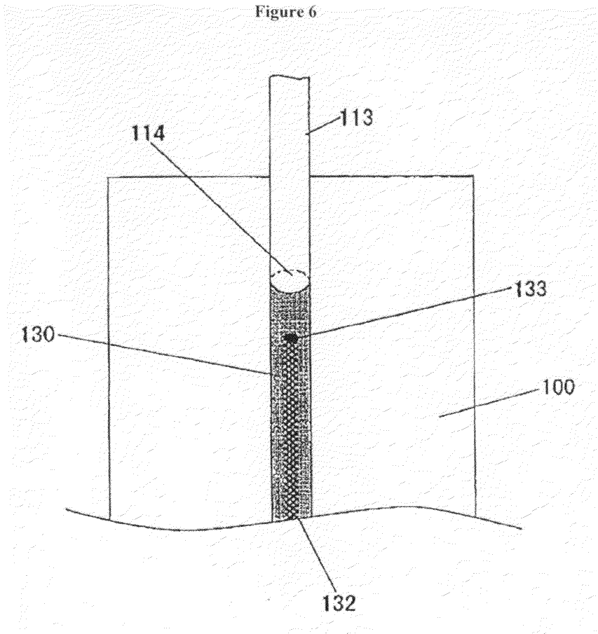

FIG. 6 shows the relation as described above. That is, the beam spot 133 is formed in a nearly central portion of the application width of the liquid material 130 applied from the opening 114, and accordingly, the liquid material 130 is sequentially processed to form the immobilized liquid material 132. At this time, the width of the immobilized liquid material 132 is equal to the size of the beam spot 133 irrespective of the application width of the liquid material 130 and the representative dimension of the opening 114. That is, in this embodiment, the immobilized liquid material 132 having the width of 0.01 mm can be obtained. With this configuration, it is possible to form a very fine, smooth and indefectible pattern using laser light having high condensation.

Further, when the pattern forming apparatus of this embodiment is used, it is possible to form a pattern with high degree of freedom even for the combination of the substrate 100 and the liquid material 130 in which it is difficult to apply the liquid material 130 by means of the typical method as described in Embodiment 2 and hence to form a pattern. The basic operation of sequentially processing the applied liquid material 130 using the laser light 121 is common throughout the present invention. Accordingly, in either a combination of the liquid material 130 and the substrate 100 in which the liquid material 130 repels and is gathered on the substrate 100 or a combination of the liquid material 130 and the substrate 100 in which the liquid material 130 is adhered to and spread into the substrate 100, the resultant formed pattern has the width specified by the size of the beam spot 133, and is smooth and has no defect.

In this manner, a substantial difference in pattern formation between Embodiment 3 and Embodiment 2 is that the relative relation between the width of the applied liquid material 130 and the size of the beam spot 133 and the width of the resultant formed pattern are specified by the size of the beam spot 133, not by the representative dimension of the opening 114. Although in this embodiment the size of the beam spot 133 is 0.01 mm, of course, the size is not limited to this value. For example, the laser light can easily form a small beam spot due to its in-phase property, and it is possible to realize an infinitesimal spot diameter size up to several μm in case of visible laser light and even up to a sub micron order in case of ultraviolet laser light having a shorter wavelength. Formation of finer patterns enables denser integration of functions and hence formation of devices having higher performance.

After the immobilization by the process using the laser light, excessive liquid material is removed in the subsequent process in this embodiment. This is a process not included in Embodiment 1 and Embodiment 2.

As is apparent from the above description, in Embodiment 3, the immobilized liquid material 132 is a portion of the applied liquid material 130 and excessive liquid material 130 that is not provided for the immobilization is left in both sides of the immobilized liquid material 132. The excessive liquid material 130 remains on the substrate 100 in either a liquefied state or a dried and solidified state depending on affinity of the liquid material 130 with the substrate 100, conditions such as application atmosphere and temperature, etc. A distribution of the liquid material 130 on the substrate 100 is in one of a state where it is unchanged as in application, a state where it is repelled and lumped in places, and a state where it is adhered to and spreads into the substrate 100. The substrate 100 in one of such states is here called a post-immobilized substrate.

The post-immobilized substrate is separated from the movable stage and the support substrate and is provided for a process of removing the excessive liquid material 130. In this embodiment, since the square fluorine-based plastic film having one side of 100 mm is used as the substrate 100 and the aqueous gold colloid dispersion solution is used as the liquid material 130, excessive gold colloid dispersion solution is repelled, gathered and then dried. As a result, dot-like excessive liquid material (gold colloid dispersion solution) 130 is adhered to both sides of the immobilized liquid material 132.

The post-immobilized substrate is immersed in 2 liters of pure water and is subjected to an ultrasonic wave treatment for 5 minutes. Accordingly, the dot-like adhered excessive liquid material 130 is re-dissolved in the water and accordingly is removed from the substrate 100. However, as described in Embodiment 1, since the immobilized liquid material 132 was changed to the state where it is not re-dissolved in the original liquid material and the solvent constituting the liquid material, the immobilized liquid material 132 strongly remains on the substrate 100. While confirming the substrate 100 by naked eyes until the excessive liquid material 130 is all removed from the substrate 100, an ultrasonic wave process is performed for the substrate 100 several times if necessary, and finally by subjecting the substrate 100 to an air drying treatment, only fine gold patterns are formed on the fluorine-based plastic film.

After the excessive liquid material 130 is removed from the substrate 100, the substrate 100 may be subjected to a new immobilizing process, a pattern surface treatment, or other modifying process. In this embodiment, the air-dried substrate 100 is put in a heating furnace at 200° C. for one hour in order to further increase adhesion of the immobilized gold to the substrate 100.

Hitherto, the pattern forming process of Embodiment 3 has been described. It should be understood that an order in a process of cleaning the post-immobilized substrate 100 has to be properly selected depending on the liquid material 130 used and other conditions. For the cleaning process, the best method is to use the solvent constituting some of the liquid material 130, and alternatively, it may be also preferable to select a separate solvent in case of the PPV monomer as described in Embodiment 1. There is also a need to optimize various parameters including ultrasonic cleaning, stirring, cleanser heating, etc.

### Embodiment 4

Next, Embodiment 4 of the present invention will be described in detail with reference to FIGS. 1, 7 and 8. The pattern forming apparatus related to Embodiment 4 has the same configuration as that in Embodiment 1 except that in the former the liquid material application mechanism has additional parts, and therefore, detailed explanation of which will be omitted and only portions different from Embodiment 1 will be described in detail.

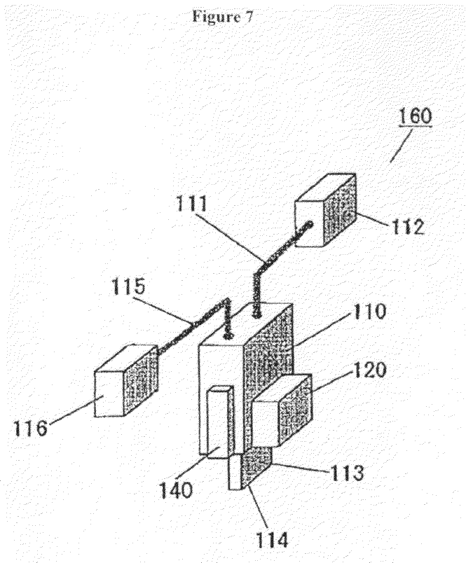

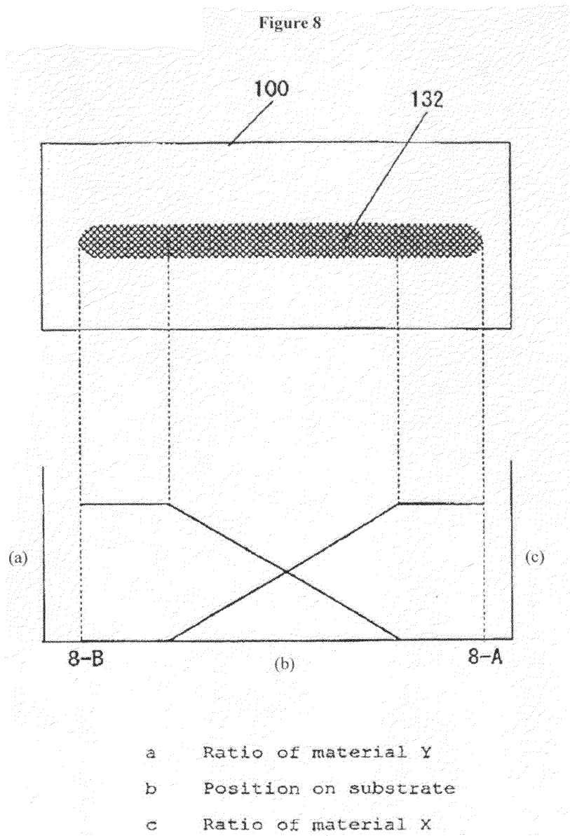

FIG. 7 is a perspective view showing a pattern forming apparatus according to Embodiment 4. A pattern forming apparatus 160 of this embodiment includes the same elements as that in Embodiment 1. In addition, the pattern forming apparatus 160 of the this embodiment further includes a transporting pipe 115, a liquid material supplying source 116, a control valve (not shown) for controlling a ratio of liquid material sent from the transporting pipe 111 to liquid material sent from the transporting pipe 115, a mixing mechanism for mixing these liquid materials. The control valve is controlled by the controller (not shown) and can change a mixture ratio according to a preset program. The above is a mechanically different portion between the pattern forming apparatus 160 of this embodiment and the pattern forming apparatus of Embodiment 1.

In addition, as to an order of immobilization, a series of flows from the application to the immobilization of the liquid material is the same as that described in Embodiment 1. However, this embodiment is different from Embodiment 1 in that the applied liquid material is formed of a plurality of materials mixed in the liquid material application mechanism 110 immediately before the application.

Now, a pattern that can be realized using the pattern forming apparatus 160 will be described below by way of an example. In Embodiment 4, the liquid material supplying source 112 is filled with liquid material in which silver fine particles are dispersed, and the liquid material supplying source 116 is filled with liquid material in which gold fine particles are dispersed. According to the order described in Embodiment 1, when a simple liner pattern is formed on the substrate, first, the above control valve is controlled in one direction for a predetermined period of time from start of the application and only the liquid material containing the silver fine particles are applied. Then, as the control valve is little by little moved with the lapse of time after a certain period of time elapses, the liquid material containing the gold fine particles begins to be sent. The liquid material containing the silver and gold fine particles sufficiently mixed in the liquid material application mechanism 110 is sequentially processed and immobilized by the laser light.

Moreover, with the lapse of time, the control valve increases the ratio of the gold fine particles to the silver fine particles in the liquid material and stops the supply of silver fine particles after a certain period of time to cause only the gold fine particles to be contained in the liquid material. Then, after lapse of pre-programmed time, the application is ended.

By forming the pattern in this manner, it is possible to form a smooth, indefectible, and very peculiar pattern having different materials between a start point and an end point. FIG. 8 shows this aspect in more detail.

In a graph of FIG. 8, a horizontal axis represents a position on the pattern (immobilized liquid material) formed on the substrate 100, and a vertical axis represents a relative ratio in amount of discharge of gold-containing the liquid material to silver-containing liquid material. Accordingly, the graph of this figure shows change of discharge amount with time of both materials in the above immobilization order, that is, a mixture ratio of both materials with respect to the position on the substrate 100. In FIG. 8, assuming that material X represents the liquid material containing silver fine particles and material Y represents the liquid material containing gold fine particles, when the application starts from an end indicated by reference numeral 8-A and ends at an end indicated by reference numeral 8-B, the above-described pattern is formed.

With the above-described pattern forming apparatus 160, two different liquid materials can be immobilized while freely changing their ratio, and, for example, when two liquid materials containing different metal particles are used, it is possible to form a pattern while randomly changing an alloy composition ratio. In addition, using an organic material and an inorganic material, it is possible to form an organic/inorganic inclined functional film. Further, this may be also applied to a method of mixing a reaction initiator, which may be unstable if it is mixed in advance, with liquid material immediately before application.

Although in this embodiment the case where two kinds of different liquid materials are mixed has been illustrated, one kind of liquid material may be mixed with a reaction initiator or three or more kinds of materials (including a reaction initiator or the like) may be mixed with each other. Although the mixture of three or more kinds of materials makes mechanism and controls of the pattern forming apparatus complicated, it has no essential difference from mixture of two kinds of materials.

In this manner, with the pattern forming apparatus 160 related to Embodiment 4, it is possible to form a pattern having peculiar composition with high degree of freedom while randomly changing a mixture ratio of a plurality of materials. It goes without saying that the pattern formed at this time is smooth and has no defect even when it has complex composition or distributions.

### Embodiment 5

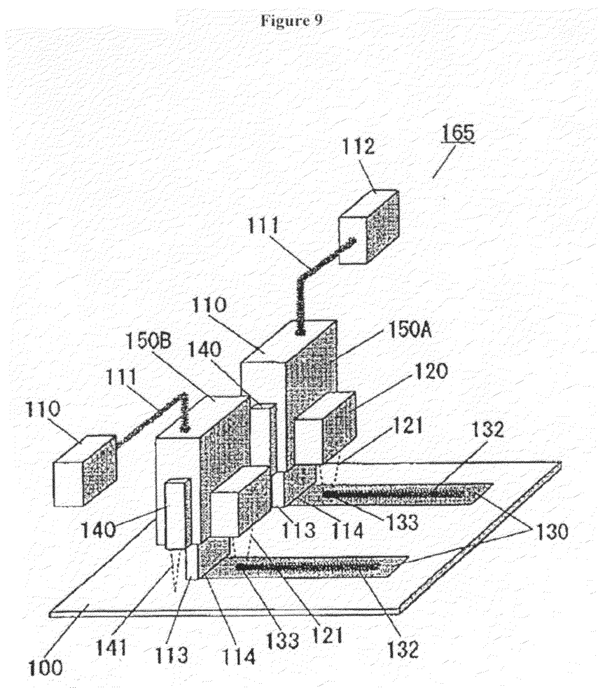

Next, Embodiment 5 of the present invention will be described in detail with reference to FIGS. 1 and 9. A pattern forming apparatus 165 related to Embodiment 5 has also the same essential elements as that in Embodiment 1 except that the pattern forming apparatus 165 of Embodiment 5 has two sets of mechanisms (hereinafter each being referred to as a forming body) each including the liquid material application mechanism 110, the laser processing mechanism 120 and the opening position measurement mechanism 140 shown in FIG. 1. In the following description, each of these sets of mechanisms is called a forming body for the purpose of avoiding complexity. In FIG. 9, reference numerals 150A and 150B each denote a forming body. Each forming body 150A and 150B can apply and immobilize the liquid materials 130 independently of each other.

With the pattern forming apparatus 165 configured so, it is possible to simultaneously form two patterns on substrate 100. In addition, it is also possible to simultaneously form patterns on two substrates. At any rate, it is possible to efficiently form smooth and indefectible patterns.

Convenience of the plurality of forming bodies is beyond the above description. For example, with the forming body 150A and the forming body 150B, it is ease to form same patterns having different materials on separate substrates or the same substrate using separate liquid materials. In this case, it goes without saying that a wavelength of the laser light 121 is properly changed to be optimized depending on the kind of used liquid materials. At this time, since the forming bodies 150A and 150B have their respective laser processing mechanisms 120, it is very ease to change the wavelength.

In addition, it is very suitable to integrate two forming bodies for pattern formation. In this case, it is possible to form a complex pattern in such a manner that a first forming body can form a first pattern by immobilizing a first liquid material, and, immediately after that, a second forming body can form a second pattern on the first pattern by immobilizing a second liquid material. For example, it is possible to achieve high degree of freedom of configuration including formation of the second pattern by silver immobilization on the first pattern formed by gold immobilization, formation of the second pattern by organic material immobilization on the first pattern formed by metal immobilization, and formation of the second pattern by functional material immobilization on the first pattern formed by immobilization of a coupling agent as a substrate surface modifier for increase of adhesion as a base material.

In addition, it is also preferable that the openings 114 respectively provided in the integrated forming bodies have different representative dimensions. With this configuration, for example, it is possible to make applications that a transparent conductor is first immobilized and then a metal material as an assistance for security of conductivity is immobilized on the transparent conductor in a width smaller than the width of the transparent conductor, a material which may be deteriorated by circumferences is immobilized and, immediately after that, a protective material is immobilized to cover the material, etc.

In any of the above cases, since the basic operation of the present invention that the liquid material is applied on the substrate and then is sequentially processed by the laser light is unchanged, the formed pattern is smooth and has no defect.

### Embodiment 6

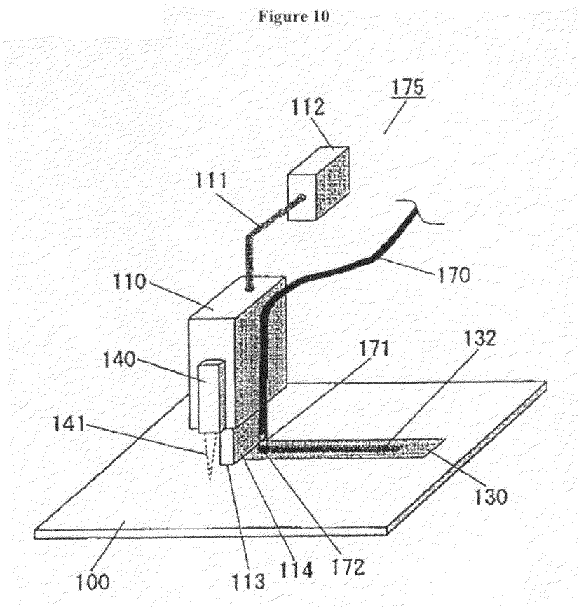

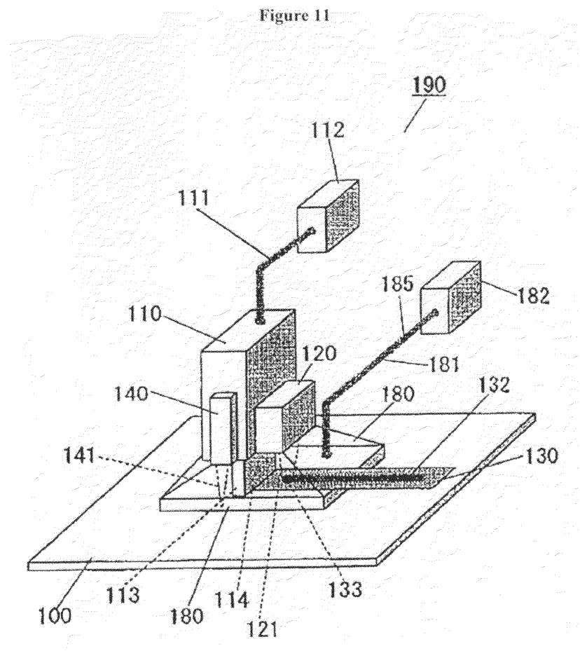

Next, Embodiment 6 of the present invention will be described in detail with reference to FIGS. 1 and 10. In FIG. 10, reference numeral 170 denotes an optical fiber, reference numeral 171 denotes laser light emitted from the optical fiber, reference numeral 172 denotes a beam spot of the laser light emitted from the optical fiber 170, and reference numeral 175 denotes a pattern forming apparatus. The pattern forming apparatus 175 related to Embodiment 6 has the similar configuration to that in Embodiment 1, and therefore, only portions different from Embodiment 1 will be described in detail.

The pattern forming apparatus 175 of this embodiment is different from that of Embodiment 1 in that the irradiation part included in the laser processing mechanism 120 (see FIG. 1) includes the optical fiber 170.

An optical fiber has been well known in the art, and therefore, detailed explanation of which will be omitted. The optical fiber 170 used in this embodiment is a single mode optical fiber used for a semiconductor laser having an emission peak wavelength of 670 nm. Of course, it is also possible to use a multi mode optical fiber. However, in the multi mode optical fiber, an expansion angle of the laser light 171 emitted from an end of an optical fiber tends to increase over that in the single mode optical fiber and the beam spot 172 tends to excessively increase in forming finer patterns.

In this embodiment, the liquid material application mechanism 110 having the same opening 114 as in Embodiment 1 is used, a solution made by dispersing silver fine particles in an organic solvent is used as the liquid material 130 as in Embodiment 1, and the application process of the liquid material 130 is similar to that in Embodiment 1.

For immobilization, a leading edge of the optical fiber 170 is disposed near a leading edge of the opening 114. The laser light 171 emitted from the optical fiber 170 spreads in the form of a cone as it becomes far away from an emission port of the optical fiber 170 and forms the beam spot 172 at an application plane of the liquid material 130. Accordingly, in this embodiment, the size of the beam spot 172 is determined depending on a distance from the section of the optical fiber 170 to the application plane of the liquid material 130. In case of combination of the semiconductor laser having the emission peak wavelength of 670 nm and the single mode optical fiber, by setting a gap between the application plane and an end of the single mode optical fiber to be 0.5 mm or so, the diameter of the beam spot 172 can be seen to be less than 0.2 mm.

With the pattern forming apparatus 175 configured above, it is possible to simplify the irradiation section and hence the entire configuration of the apparatus. The optical fiber as the irradiation section may be used as a light guide section as well. For example, modules of combinations of a high power semiconductor laser and an optical fiber are available from the market and may be used to dramatically simplify the laser processing mechanism. In addition, with use of the optical fiber, it is possible to dispose a light source at any positions, which is advantageous in the aspect of cooling of a high power light source.

In this embodiment, since the basic operation of the present invention that the liquid material 130 is applied on the substrate 100, with the opening 114 contacting the substrate 100 through the liquid material 130, and then is sequentially processed by the laser light 171 is unchanged, the formed pattern is smooth and has no defect.

### Embodiment 7

Next, Embodiment 7 of the present invention will be described with reference to FIGS. 1 to 8 and 11. A pattern forming apparatus of Embodiment 7 has the same essential structure as that of Embodiment 1 described with reference to FIG. 1, and therefore, explanation of overlapped portions will be omitted and replaced with the corresponding description for Embodiment 1, and portions added to Embodiment 1 will be described in detail.

As shown in FIG. 11, a pattern forming apparatus 190 of this embodiment further includes an atmosphere regulating mechanism 185 in addition to the pattern forming apparatus 155 shown in FIG. 1. The atmosphere control mechanism 185 is for controlling an atmosphere near the beam spot 133 for immobilizing the liquid material 130 and includes a hood 180 constituting a small chamber (atmosphere control chamber) for controlling atmosphere, a feed pipe 181 for feeding particular gas, air adjusted in temperature, or air with dusts removed therefrom to adjust the atmosphere in the atmosphere control chamber, and a control section 182 for controlling the atmosphere in the atmosphere control chamber through the feed pipe 181.

The control of the atmosphere in the atmosphere control chamber by the control section 182 is control of oxygen concentration, vapor concentration and air pressure, for example. The control section 182 maintains the atmosphere control chamber at a low oxygen concentration atmosphere in which the liquid material is not oxidized, maintains the atmosphere control chamber at a high oxygen concentration atmosphere in which the liquid material is not reduced, maintains the atmosphere control chamber at a low vapor concentration atmosphere, or maintains the atmosphere control chamber at a positive pressure or a negative pressure relative to the outside.

The configuration of the control section 182 is properly modified depending on the atmosphere to be controlled. For example, the control section 182 may be configured to include a gas cylinder, a flow rate regulating valve, etc. for the purpose of filling the atmosphere control chamber with particular gas, include a heater, a refrigerant; a pump, etc. for the purpose of controlling temperature, or include a proper filter, a fan, a pump, etc. for the purpose of removing dusts. In addition, it is also preferable that the control section 181 is configured to absorb gas within the atmosphere control chamber such that harmful gas and the like produced by immobilization of the liquid material 130 is collected and disused without being scattered.

In Embodiment 7, an order of pattern formation of the pattern forming apparatus 190 is the same as those of the above-described pattern forming apparatuses including the pattern forming apparatus of Embodiment 1. That is, in the pattern forming apparatus 190, the opening 114 is changed in its relative position with the substrate 100, the minimum representative dimension of the opening 114 is, for example, less than 500 μm, the size of the beam spot 133 for realizing the immobilization of the liquid material 130 may be larger or smaller than the minimum representative dimension of the opening 114, the opening position measurement mechanism 140 measures the gap G between the opening 114 and the substrate 100 through a process of forming a pattern, and the movable stage (not shown) is controlled by the controller such that the gap G remains constant or has a preset value.

Further, the liquid material application mechanism 110 of the pattern forming apparatus 190 can also discharge and absorb the liquid material 130 like that of Embodiment 1. In addition, it is possible to form a pattern whose composition is continuously changed using a plurality of different materials. In addition, the laser processing mechanism 120 in the pattern forming apparatus 190 of this embodiment can also emit continuous light, intermittent light and scan light like that of Embodiment 1, and its effects are also similar to those of Embodiment 1. It is also preferable that the irradiation of the laser processing mechanism 120 is configured to include an optical fiber.

In this manner, the basic operation for the pattern formation of the pattern forming apparatus 190 of Embodiment 7 of the present invention is similar to that of the pattern forming apparatus of Embodiment 1. This embodiment is different from Embodiment 1 in that the above-described pattern formation is all carried out under a controlled atmosphere.

Embodiment 7 is effective in forming a pattern using materials sensitive to an atmosphere. In this embodiment, liquid in which copper (Cu) fine particles are dispersed is used as the liquid materials 130. The copper fine particles-dispersed liquid is available from, for example, ULVAC, Inc., etc. Hereinafter, a process of forming a pattern using this material will be described in detail.

The copper fine particles can be used to form a pattern in the similar way to the silver fine particles described in Embodiment 1. That is, the copper fine particles undergo the process in which they are fused together by irradiation of laser light to be passivated. However, if this process is carried out under the typical oxygen-containing atmosphere, a physical process of fusing of particles and an oxidation reaction of copper fine particles by oxygen in air are competitively generated, and as a result, some or most of the copper fine particles are changed to copper oxide, which results in failure to obtain an intended copper pattern.

To avoid this, in the pattern forming apparatus 190 of Embodiment 7, the control section 182 includes a pure nitrogen cylinder and a flow rate regulating valve (both not shown). The flow rate regulating valve is controlled by the controller (not shown) like other mechanisms, and operates in cooperation with various sections according to a preset program. Prior to pattern formation, the pattern forming apparatus 190 operates in such a manner that the flow rate regulating valve is controlled to fill the atmosphere control chamber with pure nitrogen through the feed pipe 181. The lower end of the hood 180 is close to the substrate 100 and a gap between the hood 180 and the substrate 100 is sufficiently small. Accordingly, the pure nitrogen supplied into the atmosphere control chamber expels air including oxygen stayed in the atmosphere control chamber, while gradually filling the atmosphere control chamber. By controlling the flow rate regulating valve (not shown), the atmosphere chamber is maintained at a small positive pressure with respect to the air.

Accordingly, since the air including oxygen can not enter the atmosphere control chamber, the atmosphere in the atmosphere control chamber is substituted with the pure nitrogen with lapse of time. When preset time elapses after the supply of the pure nitrogen starts, the pattern forming apparatus 190 begins to form a pattern. Since the atmosphere control chamber is filled with the pure nitrogen without little oxygen, for example although the laser processing mechanism 120 immobilized the liquid material 130 including the copper fine particles, there occurs no or little competitive oxidation reaction in fusing of the copper fine particles, thereby substantially obtaining an intended copper pattern.

At this time, even if the movable stage (not shown) changes the relative position of the substrate 100 with the opening 114 such that the pattern (immobilized liquid material) 132 comes out of the hood 180 to be exposed to the air, since the fusing of the copper fine particles has been already completed to form a continuous metal surface, the inside of the pattern 132 is not oxidized although some of the surface of the pattern 132 may be oxidized, thereby substantially obtaining a copper pattern. Of course, when the pattern forming apparatus 190 has the plurality of forming bodies as described above and sequentially forms a pattern of a protective layer to completely cover the copper pattern, since the copper pattern can be completely prevented from being oxidized, such a configuration is more preferable.

In this manner, controlling the atmosphere when the liquid material is immobilized is very effective in widening a selection width of materials for pattern formation. Of course, although the above-described copper pattern may be formed by putting the entire apparatus within a particular controlled atmosphere, for example, a room filled with nitrogen, it is problematic in that preparation of such a large-scaled room is a troublesome work and an operator can not work within the room in the industrial and cost respects. As in this embodiment, by locally limiting a portion for atmosphere control, it is possible to construct an apparatus with high efficiency and good workability. Of course, since the pattern formation at that time is substantially carried out according to the basic operation of the present invention that the liquid material is applied on the substrate, with the opening contacting the substrate through the liquid material, and then is sequentially processed by the laser light, the formed pattern is smooth and has no defect.

Although in this embodiment the liquid material containing the copper fine particles as a material sensitive to oxygen has been described by way of an example, it is to be understood that the pattern forming apparatus of this embodiment is effective for other materials and conditions. For example, as another material sensitive to oxygen, there is liquid material containing silicon fine particles. Although this material is very dangerous in typical circumferences since it catches fire when it contacts oxygen, it is possible to form a pattern using the pattern forming apparatus of this embodiment. On the other hand, as a material requiring a high oxygen concentration atmosphere, there is liquid material containing vanadium oxide fine particles. Although vanadium oxide is apt to be changed in its composition since it may suffer oxygen deficit when being heated by laser irradiation and the like, it is possible to suppress oxygen deficit from occurring if the atmosphere control chamber is filled with oxygen. In addition, even when a material whose characteristic may be deteriorated due to vapor in an atmosphere, such as an electronic functional organic material, is used, it is possible to form a pattern using the material by removing the vapor from the atmosphere control chamber. In addition, although not described in detail, in the pattern forming apparatus 190 of this embodiment, it is possible to adjust the atmosphere control chamber to an absorption side without any separate change of configuration in order to exclude minute dusts, which are bars to formation of fine patterns, by sending clean air to the atmosphere control chamber, or collect and disuse vapor of a solvent included in the liquid material, which is produced in immobilization of the liquid material, without being scattered.

As described above, with the pattern forming apparatus of Embodiment 7, it is possible to form a smooth and indefectible pattern even using materials with which it may be difficult, unstable or impossible to form a pattern under ordinary circumferences. Further, since this apparatus controls only an atmosphere near the beam spot 133 of the laser light 121 for the immobilization, it is possible to achieve a sufficient effect even with small and simple configuration.

With the above-described pattern forming apparatus and pattern forming method, it is possible to manufacture devices having excellent characteristics, for example, printed boards, flexible boards, integrated circuits, displays, sensors, antennas, optical devices, magnetic heads, light emitting devices, wirings, electromagnetic wave shield members, solar cells, fuel cells, inductors, transformers, electronic equipments equipped with them, etc.

In addition, since the diameter of a region having an energy level at which the liquid material can be substantially immobilized is larger than the minimum representative dimension of the opening when taking a beam profile of laser light, it is ease to form a smooth and indefectible pattern having a uniform shape specified by a shape of the opening and it is possible to form a pattern with high efficiency without excessive material.

In addition, by setting the diameter of a region having an energy level, at which the liquid material can be substantially immobilized, to be larger than the minimum representative dimension of the opening when taking a beam profile of laser light, it is ease to form a smooth and indefectible pattern having a uniform shape specified by a shape of the opening and it is possible to form a pattern with high efficiency without excessive material.

In addition, by setting the diameter of a region having an energy level, at which the liquid material can be substantially immobilized, to be smaller than the minimum representative dimension of the opening when taking a beam profile of laser light, it is possible to form a very fine, smooth and indefectible pattern of less than several μm using good condensation of laser light.

In addition, in comparison with conventional inkjet methods, since a pattern can be formed into a curved shape, it is possible to form a novel, smooth and indefectible pattern on a surface of a housing of a device or at a cubic-shaped portion inside the housing, for example.

With this pattern forming method, since the liquid material is applied on the substrate from the opening contacting the substrate through the liquid material and is sequentially processed and immobilized by the laser light to form a pattern, it is further ease to precisely apply the liquid material at an intended position on the substrate as compared to pattern formation by the inkjet methods. In addition, it is also ease to form a smooth and indefectible pattern. In the meantime, like pattern formation by the inkjet methods, since it is possible to control the relative position relation between the opening and the substrate based on electronic data corresponding to a pattern to be formed, it is ease to flexibly cope with small quantity batch production. Accordingly, with this pattern forming method, it is ease to form a smooth and indefectible pattern at a desired position on the substrate while flexibly coping with small quantity batch production.

Hereinafter, like the above-described embodiments, other embodiments which are capable of easily forming a smooth and indefectible pattern at a desired position on the substrate while flexibly coping with small quantity batch production.

### Embodiment 8

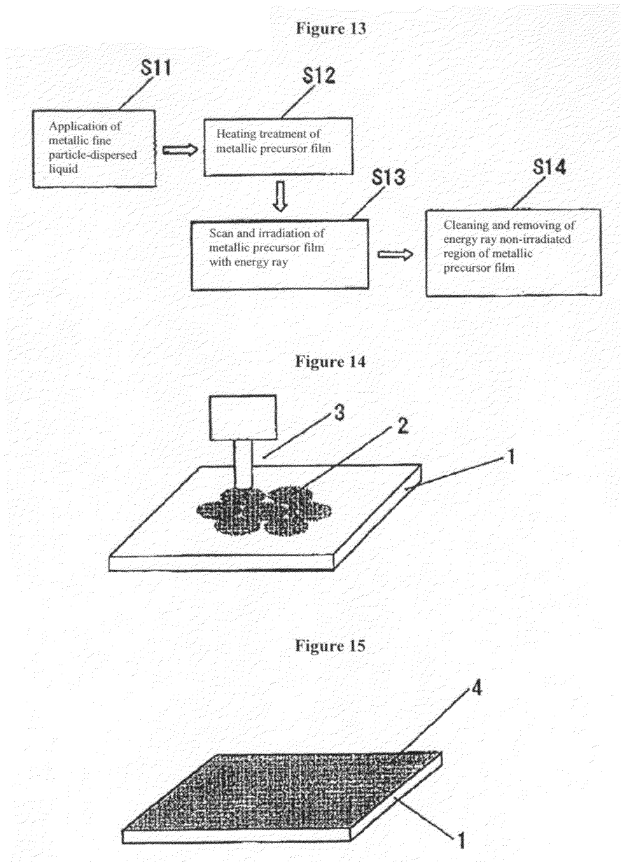

FIG. 13 is a process diagram showing a process of manufacturing a metal wiring substrate according to Embodiment 8 of the present invention. The metal wiring substrate manufacturing process includes a step S11 of applying metallic fine particle-dispersed liquid, a step S12 of heating and treating a metallic precursor film, a step S13 of scanning and irradiating the metallic precursor film with an energy ray, and a step S14 of cleaning and removing an energy ray non-irradiated region of the metallic precursor film.

The metallic fine particle-dispersed liquid application step S11 is a step of forming the metallic precursor film on a substrate surface by applying the metallic fine particle-dispersed liquid on the substrate surface, and the heating and treating step S12 is a step of subjecting the metallic precursor film formed on the substrate surface to a heating treatment. The energy ray scanning and irradiating step S13 is a step of metallizing the metallic precursor film of an energy ray irradiated region by scanning and irradiating a surface of the metallic precursor film formed on the substrate surface with an energy ray, and the energy ray non-irradiated region cleaning and removing step S14 is a step of cleaning and removing the metal precursor film of the energy ray non-irradiated region. Through these steps, a metal wiring substrate having only a region metallized by the energy ray scan and irradiation.

Here, the metallic fine particle-dispersed liquid refers to coating of surfaces of metallic fine particles having diameter of less than 50 nm, preferably less than 20 nm with a dispersing material composed of an organic compound or the like and dispersing the coating into liquid such as organic solvent or water. Such metallic fine particle-dispersed liquid containing metal such as silver, gold, copper or the like is available. The metallic fine particle-dispersed liquid has a property that metallic fine particles are fused together to form a metal body by heating at a temperature substantially lower than an inherent melting point of metal.

The metallic precursor film is a film formed by applying the metallic fine particle-dispersed liquid on the substrate. The metallic precursor film is composed of metallic fine particles whose surfaces are mainly coated with a dispersing material composed of an organic compound or the like, with a portion of solvent, which composes the metallic fine particle-dispersed liquid, evaporated. When such a film is heated at more than predetermined temperature, the dispersing material composed of the organic compound or the like is removed from the surfaces of the metallic fine particles, and active metallic fine particles are fused together to form a metal body. In particular, it is known that temperature at which the metallic fine particles are fused together becomes significantly lower than the inherent melting point of metal as the diameter of the metallic fine particles becomes smaller.

Now, the method of forming the metal wiring substrate according to Embodiment 8 of the present invention will be described in detail. FIGS. 2 to 7 are views showing examples of a process order of a method of forming a metal wiring substrate according to Embodiment 8 of the present invention.

Here, a glass substrate is used as a substrate 1. First, metallic fine particle-dispersed liquid 2 is applied on a cleaned glass substrate 1 by spin coating. In more detail, as shown in FIG. 14, after the metallic fine particle-dispersed liquid 2 is dropped on the entire surface of the glass substrate 1 set on a spin coater (not shown) using a pipette 3, a film composed of the metallic fine particle-dispersed liquid 2 is formed on the surface of the glass substrate 1 by maintaining the glass substrate 1 for a predetermined period of time at a predetermined rotation speed, for example, for 30 seconds at a rotation speed of 1000 rotations/min. When the spin coating is performed after dropping the metallic fine particle-dispersed liquid 2 on the glass substrate 1, extra metallic fine particle-dispersed liquid 2 is scattered and a portion of solvent of the metallic fine particle-dispersed liquid 2 remaining on the surface of the glass substrate 1 is evaporated to form a reddish brown film on the surface of the glass substrate 1. As shown in FIG. 15, the metallic fine particle-dispersed liquid 2 dropped on the glass substrate 1 is spin-coated. A film remaining on the surface of the glass substrate 1 is referred to as a metallic precursor film 4.

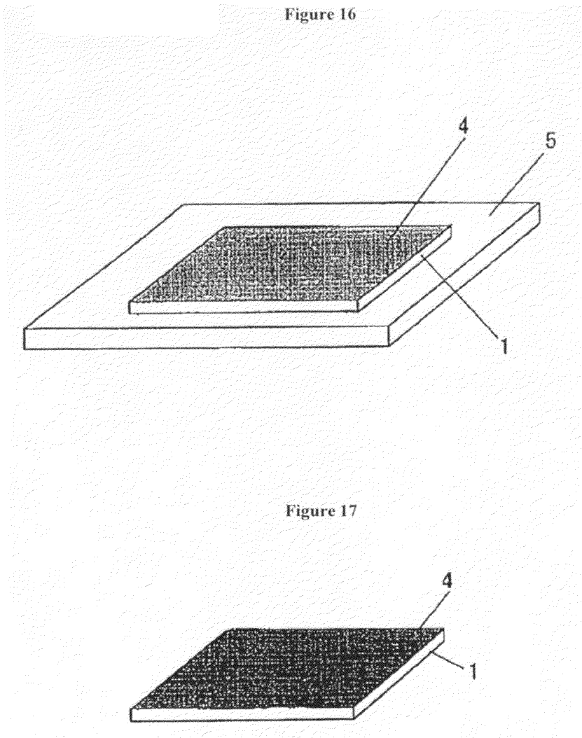

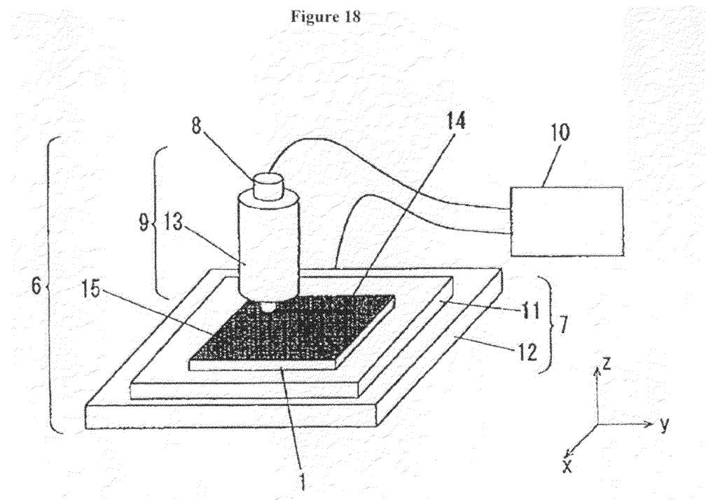

Subsequently, the metallic precursor film 4 formed on the surface of the glass substrate 1 is subjected to a heating treatment. In Embodiment 8, as shown in FIG. 16, by placing the glass substrate 1, on which the metallic precursor film 4 is formed, on a heated hot plate 5, the metallic precursor film 4 is subjected to the heating treatment. Here, the heating treatment is performed by placing the glass substrate 1 on the hot plate 5, temperature of which is set such that temperature of the surface of the glass substrate 1 becomes 250° C., for 50 seconds. As shown in FIG. 17, when the metallic precursor film 4 is subjected to the heating treatment, color of the metallic precursor film 4 appears to be deep as compared to before it is heated.

Subsequently, a surface of the metallic precursor film 4 subjected to the heating treatment is scanned and irradiated with an energy ray. FIG. 18 is a view showing a general configuration of an energy ray irradiation and scan apparatus. In Embodiment 8, a laser light ray using a semiconductor laser is used as the energy ray.

In FIG. 18, reference numeral 6 denotes an energy ray irradiation and scan apparatus, reference numeral 7 denotes a substrate holder portion mounted with the substrate 1 on which the metallic precursor film 4 is formed, reference numeral 8 denotes a semiconductor laser as a laser light source, reference numeral 9 denotes a laser light emitting portion, reference numeral 10 denotes a controller for controlling the substrate holder 7 and the laser light emitting portion 9, reference numeral 11 denotes a substrate holder for holding and fixing the substrate 1 on which the metallic precursor film 4 is formed, reference numeral 12 denotes a driving system for driving the substrate holder 11 in xyz 3-axis directions with respect to laser light emitted from the laser light emitting portion 9 based on a signal from the controller 10, reference numeral 13 denotes an optical system for shaping a light ray emitted from the laser light source 8, reference numeral 14 denotes a metal film, and reference numeral 15 denotes a laser light non-irradiated region. Here, the substrate holder 11 and the driving system 12 constitute the substrate holder portion 7 and the laser light source 8 and the system 13 constitute the laser light emitting portion 9. In FIG. 18, directions perpendicular to each other on the substrate holder 11 (substrate 1) are represented by x and y direction and a direction (a traveling direction of the laser light emitted from the laser light emitting portion 9) perpendicular to the x and y directions is represented by a z direction.

In Embodiment 8, a semiconductor laser having a wavelength of 670 nm and power of 800 mW is used as the light source. The optical system 13 includes a collimator leans, a prism, a condensing lens, etc., and is configured such that the light ray emitted from the laser light source 8 is focused on the surface of the glass substrate 1 fixed on the substrate holder 11. The laser light source 8 operates based on a signal from the controller 10.

Now, an operation of the energy ray irradiation and scan apparatus 6 will be described. First, the glass substrate 1 formed thereon with the metallic precursor film 4 is set on the substrate holder 11. The setting of the glass substrate 1 on the substrate holder 11 may be made by, for example, fixing a rear side of the glass substrate 1 by means of a vacuum chuck. The substrate holder 11 is moved in the xyz directions with respect to a direction of emission of the laser light based on the signal from the controller 10.

Subsequently, the laser light source 8 is driven to emit the laser light based on a signal from the controller 10. The emitted laser light is shaped by passing the optical system 13 and the glass substrate 1 fixed on the substrate holder 11 is irradiated with the shaped laser light. A position of the substrate holder 11 in the z direction is controlled based on a signal from the controller 10 so that the laser light with which the glass substrate 1 is irradiated is focused on the glass substrate 1. In this manner, the surface of the metallic precursor film 4 formed on the surface of the glass substrate 1 is irradiated with the laser light. The laser light is partially reflected, partially transmitted, and partially absorbed in the metallic precursor film 4. By such action of the laser light on the metallic precursor film 4, some of the laser light becomes thermal energy to heat a portion of the metallic precursor film 4 with which the laser light is irradiated.

The metallic precursor film 4 is a film composed of metallic fine particle-dispersed material. When the metallic precursor film is heated to exceed a predetermined temperature, metallic fine particles included in the metallic precursor film 4 are fused together, thereby substantially converting the metallic fine particles into a continuous metal film 14. In this manner, by irradiating the surface of the metallic precursor film 4 with the laser light and heating the portion of the film 4 with which the laser light is irradiated, a minute metal film 14 is formed.

In the meantime, since the substrate holder 11 is moved in the xy direction based on a signal from the controller 10, any position on the metallic precursor film 4 can be irradiated with the laser light. That is, it is possible to irradiate and scan the metal precursor film 4 with the laser light while moving the glass substrate 1.

In this manner, when the metallic precursor film 4 is irradiated with the laser light to heat the metallic precursor film 4, the metallic precursor film 4 is converted into the metal film 14. Specifically, a region on the metallic precursor film 4 through which the laser light passes is converted into the metal film 14. Thus, a linear metal film 14 is formed on the glass substrate 1. When a continuous line (wiring) is formed as the linear metal film 14, the film 4 may be irradiated and scanned with continuous laser light. However, by decreasing or intermitting input power of the laser light source 8 or providing a light shielding device between the laser light and the metallic precursor film 4, it is possible to easily form an intermittent line other than the continuous line.

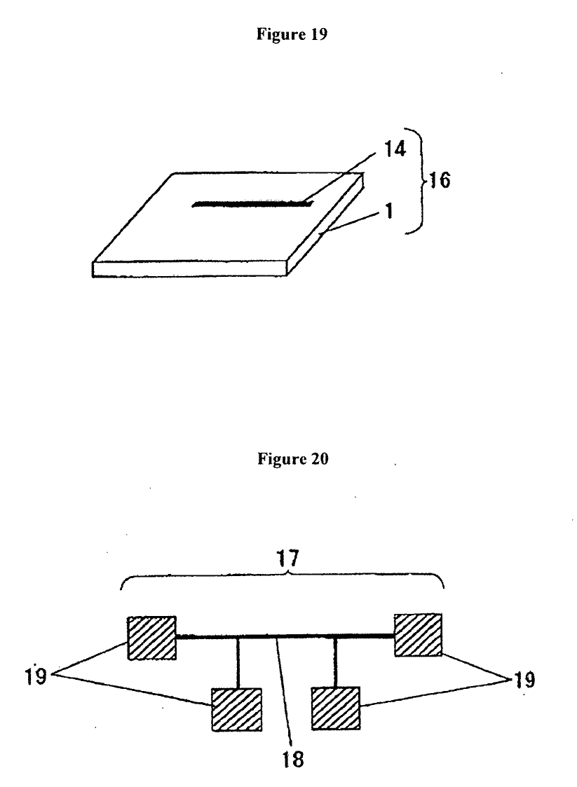

In this manner, by irradiating the metallic precursor film 4 with the laser light, the metallic precursor film 4 becomes the metal film 14, forming a metal pattern. However, the laser light non-irradiated region 15 is a metallic precursor film 4. Since this metallic precursor film 4 is an aggregate of metallic fine particles, it is an unstable material and thus it is preferable to remove it for use as the metal wiring substrate 16. The metallic precursor film 4 of the laser light non-irradiated region 15 may be removed by dipping the glass substrate 1 into the solvent used in the metallic fine particle-dispersed liquid 2. This is because the metallic precursor film 4 remaining in the glass substrate 1 can be swelled and easily removed by being dipped into the solvent used in the metallic fine particle-dispersed liquid 2. If it is difficult to remove the metallic precursor film 4, an ultrasonic cleaner may be used. Finally, as shown in FIG. 19, when the glass substrate 1 is rinsed with the same solvent as the solvent used in the metallic fine particle-dispersed liquid 2, the metal wiring substrate 16 is formed on the glass substrate 1.

Next, the following test sample is prepared in order to examine a heating treatment effect after forming the metallic precursor film 4 according to Embodiment 8 and a result of examination on electrical resistance of wirings of the sample is shown.

FIG. 20 is a view showing a wiring pattern of a test sample according to Embodiment 8 of the present invention. In the figure, reference numeral 17 denotes a wiring pattern, reference numeral 18 denotes a straight line portion of the wiring pattern, and reference numeral 19 denotes four terminal portions used to measure electrical resistance of the straight resistance 18. While the wiring pattern 17 as shown in FIG. 20 is formed according to the above-described manufacturing method, the terminal portions 19 may be formed by overlapped irradiation and scan of the laser light. Here, the straight line portion 18 of the wiring pattern 17 is formed while changing an irradiation and scan speed. Hereinafter, a method of manufacturing a metal wiring substrate having the wiring pattern shown in FIG. 20 will be described in detail, and then a result of measurement on the electrical resistance of the wiring.

A glass substrate was used as the substrate 1, and Ag1T (product name) available from ULVAC Materials, Inc. was used as the metallic fine particle-dispersed liquid 2. A test sample of Embodiment 8 was one that is subjected to a heating treatment by placing the glass substrate 1 on a hot plate, temperature of which was set such that temperature of the surface of the glass substrate becomes 250° C., for 50 seconds after forming the metallic precursor film 4 by applying the metallic fine particle-dispersed liquid 2 on the glass substrate 1 by spin coating. A plurality of test samples each subjected to the heating treatment was formed.

In addition, like the test samples for Embodiment 8, glass substrates each formed thereon with the metallic precursor film 4 that was subjected to no heating treatment were formed as test samples for Comparative Example 1.

Subsequently, the metallic precursor films 4 of the glass substrates 1 of Embodiment 8 and the glass substrates 1 of Comparative Example 1 were irradiated with laser light using the above-described laser light irradiation and scan apparatus 6 to form the wiring pattern 17 shown in FIG. 20. At this time, each test sample was irradiated with the laser light while changing an irradiation and scan speed of the laser light (moving speed of the substrate holder 11 in the x direction). Finally, the laser light non-irradiated region 15 of the metallic precursor film 4 was dipped and removed into toluene as solvent of the metallic fine particle-dispersed liquid 2, and was rinsed, thereby preparing the test samples of Embodiment 8 and the test samples of Comparative Example 1. Next, electrical resistance between terminal portions 19 was measured. Table 1 shows a result of measurement of electrical resistance for the test samples of Embodiment 8 and Comparative Example 1.

TABLE 1

| Sample scan speed (mm/s) | 5 | 10 | 15 | 20 | 30 |
|---|---|---|---|---|---|
| Resistance of Embodiment 8 (Ω) | 7.5 | 7.8 | 7.7 | 7.6 | 7.9 |
| Resistance of Comparative | 7.4 | 7.7 | 8.2 | 8.5 | 18 |
| Example 1 (Ω) | | | | | |

As shown in Table 1, for the test samples of Embodiment 8, the electrical resistance of the straight line portion 18 is constant as about 7.8Ω even with increase of laser light irradiation and scan speed. On the other hand, for the test samples of Comparative Example 1, the electrical resistance of the straight line portion 18 tended to increase with increase of laser light irradiation and scan speed, finally leading to sudden increase.

For the test samples of Embodiment 8, even with increase of laser light irradiation and scan speed, it is believed that the stable electrical resistance is due to the conversion of the metallic precursor film 4 into the metal film 14 by the irradiation of the laser light, that is, the mutual fusing of metallic fine particles forming the metallic precursor film 4, irrespective of the irradiation and scan speed of the test samples.

For the test samples of Comparative Example 1, with increase of laser light irradiation and scan speed, it is believed that the increase of electrical resistance of the straight line portion 18 is due to incompletion of the conversion of the metallic precursor film 4 into the metal film 14 by the irradiation of the laser light, that is, the mutual fusing of metallic fine particles forming the metallic precursor film 4.

In actuality, from observation of surfaces of the test samples, it is confirmed that the metal film 14 had a smooth surface irrespective of the irradiation and scan speed for the test samples of Embodiment 8, while smoothness of the surface of the metal film 14 disappeared with increase of the irradiation and scan speed for the test sample of Comparative Example 1. In this manner, in Embodiment 8 that carries out the heating treatment before irradiating the metallic precursor film 4 with the laser light, it is possible to form the smooth metallic film 14 even with increase of the irradiation and scan speed of the laser light, unlike Comparative Example 1 that carries out no heating treatment before irradiating the metallic precursor film 4 with the laser light. It is believed that the reason for this is that the conversion of the metallic precursor film 4 into the metal film 14 by heating, that is, the thermal fusing of metallic fine particles forming the metallic precursor film 4, is apt to occur by heating the metallic precursor film 4 in advance.

Although in Embodiment 8 the metallic precursor film 4 is subjected to the heating treatment under conditions of 250° C. and 50 seconds, these conditions depend on factors such as the thickness of the metallic precursor film 4, the kind and diameter of metallic fine particles forming the metallic precursor film 4, a dispersing agent covering the circumference of individual metallic fine particles, etc., and thus optimal conditions may be determined in consideration of such factors. It should be here noted that the heating treatment of the metallic precursor film 4 is required to stop immediately before the fusing of metallic fine particles occurs. After forming the wiring pattern on the metallic precursor film 4 by the irradiation and scan of the laser light, the laser light non-irradiated region 15 of the metallic precursor film 4 is rinsed and removed using the solvent of the metallic fine particle-dispersed liquid. However, if the heating treatment is carried out under conditions such as occurrence of the fusing of metallic fine particles, the laser light non-irradiated region 15 may not be cleaned and removed as it has already been metallized to form a film. As a result, an unintended pattern is formed, which may raise short-circuit between intended wiring patterns. Therefore, the heating treatment under the conditions such as occurrence of the fusing of metallic fine particles is not preferable.

Although in Embodiment 8 the metallic precursor film 4 is metallized by the irradiation of the laser light in a different step after the heating treatment step of the metallic precursor film 4, the metallic precursor film 4 may be metallized by the irradiation of the laser light during the heating treatment step of the metallic precursor film 4. However, the metallization of the metal precursor film 4 by heating depends on heating temperature and heating time. Accordingly, depending on conditions of heating treatment, for example if it takes a long time to form a metal film by irradiation of the laser light, such as in forming a complicated wiring pattern, an attention must be paid since the metallic precursor film 4 may be possibly converted into a metal film during the irradiation of the laser light.

Although in Embodiment 8 the heating treatment of the metallic precursor film 4 is carried out using the hot plate 5, this is employed from a standpoint of ease of observation of surface variation when the metallic precursor film 4 is converted into the metal film 14. Therefore, the heating treatment of the metallic precursor film 4 may be carried out using heating means such as an electric furnace, an oven, an infrared heating furnace, etc. other than the hot plate 5.

Although in Embodiment 8 the glass substrate is used as the substrate 1, without being limited to this, a ceramic substrate, a glass epoxy substrate, a flexible polyimide substrate, etc. which are being commonly used in a wiring board, may be used as the substrate 1.

Although in Embodiment 8 irradiation time (i.e., heating time) of the laser light is reduced by increasing the scan speed, laser power may be weakened while adjusting the scan speed, that is, the heating time. This is effective in forming a metal wiring substrate in a substrate having low heat resistance.

Although in Embodiment 8 the wiring thickness is small as 0.5 μm, the wiring thickness may become large by additionally forming a plating film on the wiring.

As described above, in Embodiment 8, by forming the metallic precursor film 4 on the substrate 1 from the metallic fine particle-dispersed liquid 2, heating the metallic precursor film 4 under the conditions where there occurs no fusing of metallic fine particles, and forming the metal film 14 by scanning and irradiating the metallic precursor film 4 with the energy ray such as the laser light, it is possible to form the metal wiring without using an expensive apparatus such as a photolithography apparatus. In addition, it is possible to form any wiring pattern 17 having fine wiring width based on power of the laser light from the controller without using a mask such as a photomask.

In addition, since the wiring pattern 17 having high adhesion with the substrate 1 can be formed without mixing a photothermal conversion material with the metallic fine particle-dispersed liquid 2 or providing a photothermal conversion layer between the substrate 1 and the metallic precursor film 4, it is possible to further simplify a process as compared to conventional metal wiring manufacturing methods. In addition, since the energy ray required to metallize the metallic precursor film can be made small in the energy ray scan and irradiation, it is possible to miniaturize an energy ray output apparatus (scan and irradiation apparatus). In addition, by increasing the energy ray irradiation and scan speed as conventional without decreasing power of the energy ray, it is possible to reduce time taken to manufacture the metal wiring substrate and improve productivity.

In addition, since the metallic precursor film is left as it is without being changed to metal through a process and thus conventional methods can be used to remove the energy ray non-irradiated portion on the metallic precursor film, it is possible to introduce the manufacturing method of the present invention into the conventional metallic wiring substrate manufacturing methods.

### Embodiment 9

The heating treatment process of Embodiment 8 has been carried out using the hot plate. In Embodiment 8, by subjecting the metallic precursor film to the heating treatment, the irradiation and scan speed can be increased in the subsequent energy ray irradiation and scan process. Although this is effective in manufacture of the metallic wiring substrate, there is a need of the heating treatment process. In Embodiment 9, a case where the heating treatment process is performed with irradiation of an energy ray to further simplify the process as compared to Embodiment 8 will be described.

A method of manufacturing a metal wiring substrate of Embodiment 9 is similar to that shown in the process diagram shown in FIG. 13 except that the heating treatment step S12 is carried out by heating the metallic precursor film by means of irradiation of a first energy ray. In this case, in the energy ray scanning and irradiating step S13, a surface of the metallic precursor film formed on the substrate surface is scanned and irradiated with a second energy ray to metallize the metallic precursor film in a region irradiated with the second energy ray. Other steps are similar to those in Embodiment 8, and therefore explanation of which will be omitted.

Next, the metal wiring substrate manufacturing method of Embodiment 9 will be described in detail by way of an example. First, NPS-J (product name), which contains silver as metal and is available from Harima Chemicals, Inc., is used as metallic fine particle-dispersed liquid. A cleaned glass substrate is set on a spin coater and the metallic fine particle-dispersed liquid is applied on the cleaned glass substrate by spin coating. In more detail, after the metallic fine particle-dispersed liquid is dropped on the entire surface of the glass substrate using a pipette, a film composed of the metallic fine particle-dispersed liquid, that is, the metallic precursor film 4, is formed on the surface of the glass substrate by maintaining the glass substrate for a predetermined period of time at a predetermined rotation speed, for example, for 30 seconds at a rotation speed of 1000 rotations/min.

Subsequently, in Embodiment 9, the metallic precursor film is heated with irradiation of the first energy ray, and, at the substantial same time, metal formation of the heated metallic precursor film is performed with the second energy ray.

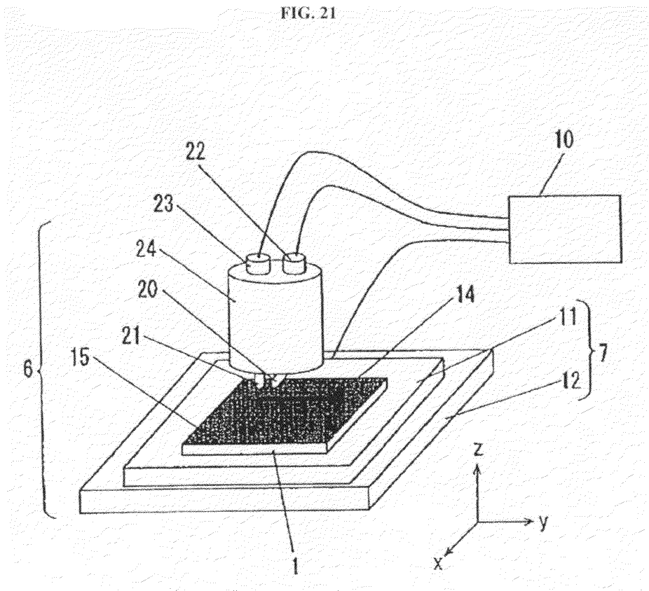

FIG. 21 is a view showing a general configuration of a laser ray irradiation scan apparatus according to Embodiment 9 of the present invention. In FIG. 21, reference numeral 20 denotes a first laser light emitting portion, reference numeral 21 denotes a second laser light emitting portion, reference numeral 22 denotes a first laser light source, reference numeral 23 denotes a second laser light source, and reference numeral 24 denotes an optical system which shapes laser light emitted from the first and second laser light sources 22 and 23 and leads the shaped laser light to the first and second laser light emitting portions 20 and 21. In this Embodiment 8, the same elements as the laser light irradiating and scanning apparatus of Embodiment are denoted by the same reference numerals, and explanation of which will be omitted. In FIG. 21, directions perpendicular to each other on the substrate holder 11 (substrate 1) are represented by x and y direction and a direction (a traveling direction of the laser light emitted from the second laser light emitting portion 21) perpendicular to the x and y directions is represented by a z direction.

In Embodiment 9, a semiconductor laser having a wavelength of 830 nm and power of 500 mW is used as the first laser light source 22 and a second semiconductor laser having a wavelength of 670 nm and power of 800 mW is used as the second laser light source 23. The optical system 24 includes a collimator leans, a prism, a condensing lens, etc., and is configured such that the laser light emitted from the first and second laser light sources 22 and 23 is focused on the surface of the substrate 1 fixed on the substrate holder 11. The first and second laser light sources 22 and 23 operate based on a signal from the controller 10.

Now, an operation of the energy ray irradiation and scan apparatus 6 will be described. First, at Step S11, the substrate 1 formed thereon with the metallic precursor film 4 is set on the substrate holder 11. The setting of the substrate 1 may be made by, for example, fixing a rear side of the substrate 1 by means of a vacuum chuck. The substrate holder 11 is moved in the xyz directions with respect to a direction of emission of second laser light emitted from the second laser light emitting portion 21 based on the signal from the controller 10.

The first laser light source 22 is driven to emit the first laser light based on a signal from the controller 10. The emitted first laser light is shaped by passing the optical system 24 and a surface of the substrate 1 fixed on the substrate holder 11 is irradiated with the shaped first laser light. A position of the substrate holder 11 in the z direction is controlled based on a signal from the controller 10 so that the first laser light with which the substrate 1 is irradiated is focused on the substrate. In this manner, the surface of the metallic precursor film 4 formed on the surface of the substrate 1 is irradiated with the first laser light. The first laser light is partially reflected, partially transmitted, and partially absorbed in the metallic precursor film 4. By such action of the first laser light on the metallic precursor film 4, some of the first laser light becomes thermal energy to heat a portion of the metallic precursor film 4 with which the first laser light is irradiated.

Although the heating treatment of the metal precursor film 4 is carried out by the irradiation of the first laser light, conditions on the irradiated region, irradiation energy, etc. of the first laser light may depend on factors such as the thickness of the metallic precursor film 4, the kind and diameter of metallic fine particles forming the metallic precursor film 4, a dispersing agent covering the circumference of individual metallic fine particles, etc., and thus optimal conditions may be determined in consideration of such factors, as described in Embodiment 8. It should be here noted that the heating treatment of the metallic precursor film 4 is required to stop immediately before the fusing of metallic fine particles occurs. After forming the metal film 14 on the metallic precursor film 4 by the scan and irradiation of the second laser light, a second laser light non-irradiated region 15 of the metallic precursor film 4 is rinsed and removed using the solvent of the metallic fine particle-dispersed liquid. However, if the heating treatment is carried out under conditions such as occurrence of the fusing of metallic fine particles, the second laser light non-irradiated region 15 may not be cleaned and removed as it has already been metallized to form a film. As a result, an unintended pattern is formed on the substrate 1, which may raise short-circuit between intended wiring patterns. Therefore, the heating treatment under the conditions such as occurrence of the fusing of metallic fine particles is required to stop.

Almost at the same time of irradiating the metallic precursor film 4 with the first laser light, the second laser light source 23 is driven to emit the second laser light based on a signal from the controller 10. The emitted second laser light is shaped by passing the optical system 24 and a surface of the substrate 1 fixed on the substrate holder 11 is irradiated with the shaped second laser light. A position of the substrate holder 11 in the z direction is controlled based on a signal from the controller 10 so that the second laser light with which the substrate 1 is irradiated is focused on the substrate 1. In this manner, the surface of the metallic precursor film 4 formed on the surface of the substrate is irradiated with the second laser light. The second laser light is partially reflected, partially transmitted, and partially absorbed in the metallic precursor film 4. By such action of the second laser light on the metallic precursor film 4, some of the second laser light becomes thermal energy to heat a portion of the metallic precursor film 4 with which the second laser light is irradiated.

Here, the metallic precursor film 4 is a film composed of metallic fine particle-dispersed material. When the metallic precursor film 4 is heated to exceed a predetermined temperature, metallic fine particles included in the metallic precursor film 4 are fused together, thereby substantially converting the metallic fine particles into a continuous metal film 14. In this manner, by irradiating the surface of the metallic precursor film 4 with the second laser light and heating the portion of the film 4 with which the second laser light is irradiated, a minute metal film 14 is formed.

In the meantime, since the substrate holder 11 is moved by the driving system 12 in the xy direction based on a signal from the controller 10, any position on the metallic precursor film 4 can be irradiated with the first and second laser light. That is, it is possible to irradiate and scan the metal precursor film 4 with the first and second laser light while moving the substrate 1.

In this manner, when the metallic precursor film 4 is irradiated with the first laser light to heat the metallic precursor film 4, the metallic precursor film 4 goes into a state where it is apt to be converted into the metal film 14, that is, a state immediately before metallic fine particles are fused together. Specifically, when the surface of the metallic precursor film 4 is irradiated with the first laser light, the metallic precursor film 4 of a region through which the first laser light passes may be converted into the metallic precursor film 4 which is apt to be converted into the metal film 14. Thus, a heating treated region of a linear metal film 14 is formed. When a continuous line (wiring) is formed as the linear metal film 14, the film 4 may be irradiated and scanned with continuous laser light. However, by decreasing or intermitting input power of the first and second laser light sources 22 and 23 or providing a light shielding device between the laser light and the metallic precursor film 4, it is possible to easily form an intermittent line other than the continuous line.

In addition, when the metallic precursor film 4 is irradiated with the second laser light to heat the metallic precursor film 4, the metallic precursor film 4 is converted into the metal film 14. Specifically, when the surface of the metallic precursor film 4 is irradiated with the second laser light, a region of the metallic precursor film 4 through which the second laser light passes can be converted into the metal film 14. Thus, a linear metal film 14 is formed on the substrate 1. When the linear metal film 14 is continuous, the film 4 may be continuously irradiated and scanned with the second laser light. However, by decreasing or intermitting input power of the second laser light source 23 or providing a light shielding device between the second laser light and the metallic precursor film 4, it is possible to easily form an intermittent line other than the continuous line.

In this manner, by irradiating the metallic precursor film 4 with the first and second laser light, the metallic precursor film 4 becomes the metal film 14, forming a metal wiring substrate 16. However, the second laser light non-irradiated region 15 is a metallic precursor film 4. Since this metallic precursor film 4 is an aggregate of metallic fine particles, it is an unstable material and thus it is preferable to remove it for use as the metal wiring substrate 16. The metallic precursor film 4 of the second laser light non-irradiated region 15 may be removed by dipping the substrate into the solvent used in the metallic fine particle-dispersed liquid 2. This is because the metallic precursor film 4 remaining in the substrate 1 can be swelled and easily removed by being dipped into the solvent used in the metallic fine particle-dispersed liquid 2. If it is difficult to remove the metallic precursor film 4, an ultrasonic cleaner may be used. Finally, when the substrate is rinsed with the same solvent as the solvent used in the metallic fine particle-dispersed liquid 2, the metal wiring substrate 16 is formed on the substrate 1.

In this manner, the metal wiring substrate 16 is formed by applying the metallic fine particle-dispersed liquid 2 on the substrate 1. Next, the following test sample was prepared in order to examine a heating treatment effect after forming the metallic precursor film 4 according to Embodiment 9 and a result of examination on electrical resistance of a wiring pattern 17 of the sample was shown. The wiring pattern 17 of the test sample is the same as the wiring pattern 17 shown in FIG. 20 illustrating Embodiment 8. Like Embodiment 8, a straight line portion 18 of the wiring pattern 17 was formed while changing a laser light irradiation and scan speed.

A glass substrate was used as the substrate 1, and NPS-J (product name) available from Harima Chemicals, Inc. was used as the metallic fine particle-dispersed liquid 2. A plurality of metallic precursor films 4 was formed by applying the metallic fine particle-dispersed liquid 2 on the glass substrate by spin coating.

Subsequently, the metallic precursor film 4 of the substrates 1 was irradiated with laser light using the laser light irradiation and scan apparatus 6 shown in FIG. 21 to form the wiring pattern 17 shown in FIG. 20. At this time, each test sample was irradiated with the laser light while changing a laser light irradiation and scan speed (moving speed of the substrate holder 11 in the x direction). Here, as shown in FIG. 21, after heating the metallic precursor film 4 by irradiation of the first laser light, the metallic precursor film 4 was converted into the metal film 14 by irradiation of the second laser light to form the wiring pattern 17. Finally, the second laser light non-irradiated region 15 of the metallic precursor film 4 was dipped and removed into tetradecane as solvent of the metallic fine particle-dispersed liquid 2, and was rinsed, thereby preparing the test samples of Embodiment 9.

As comparative samples, like the test samples of Embodiment 9, the metallic precursor film 4 was formed on the glass substrate, and the wiring pattern 17 was formed by laser light irradiation using the above-described laser light irradiation and scan apparatus 6 while changing a laser light irradiation and scan speed (moving speed of the substrate holder 11 in the x direction). Here, in Comparative Example 2, the metallic precursor film 4 was converted into a metal film to form the wiring pattern 17 by only irradiation of the second laser light without irradiation of the first laser light, that was, without heating the metallic precursor film 4. Finally, like Embodiment 9, the second laser light non-irradiated region 15 of the metallic precursor film 4 was dipped and removed into tetradecane as solvent of the metallic fine particle-dispersed liquid 2, and was rinsed, thereby preparing the samples of Comparative Example 2. Next, electrical resistance between terminal portions 19 of the samples of Embodiment 9 and Comparative Example 2 was measured. Table 2 shows a result of measurement of electrical resistance for the samples of Embodiment 9 and Comparative Example 2.

TABLE 2

| Sample scan speed (mm/s) | 5 | 10 | 15 | 20 | 30 |
|---|---|---|---|---|---|
| Resistance of Embodiment 9 (Ω) | 4.2 | 4.1 | 4.3 | 4.2 | 4.4 |
| Resistance of Comparative | 4.2 | 4.3 | 4.8 | 7.2 | 12 |
| Example 2 (Ω) | | | | | |

As shown in Table 2, for the samples of Embodiment 9, the electrical resistance of the straight line portion is constant as about 4.2Ω even with increase of first and second laser light irradiation and scan speed. On the other hand, for the samples of Comparative Example 2, the electrical resistance of the straight line portion tends to increase with increase of second laser light irradiation and scan speed, finally leading to sudden increase.

For the samples of Embodiment 9, even with increase of laser light irradiation and scan speed, it is believed that the stable electrical resistance is due to the conversion of the metallic precursor film 4 into the metal film 14 by the irradiation of the second laser light, that is, the mutual fusing of metallic fine particles forming the metallic precursor film 4, irrespective of the scan speed of the test samples.

For the samples of Comparative Example 2, with increase of second laser light irradiation and scan speed, it is believed that the increase of electrical resistance of the straight line portion is due to incompletion of the conversion of the metallic precursor film 4 into the metal film 14 by the irradiation of the second laser light, that is, the mutual fusing of metallic fine particles forming the metallic precursor film 4.

In actuality, from observation of surfaces of the samples, it is confirmed that the metal film 14 has a smooth surface irrespective of the irradiation and scan speed for the samples of Embodiment 9, while smoothness of the surface of the metal film 14 disappears with increase of the irradiation and scan speed for the test sample of Comparative Example 2. In this manner, in Embodiment 9 that carries out the heating treatment by irradiating the metallic precursor film 4 with the first laser light before irradiating the metallic precursor film 4 with the second laser light, it is possible to form the smooth metallic film 14 even with increase of the irradiation and scan speed of the second laser light, unlike Comparative Example 2 that carries out no heating treatment before irradiating the metallic precursor film 4 with the second laser light. It is believed that the reason for this is that the conversion of the metallic precursor film 4 into the metal film 14 by heating, that is, the thermal fusing of metallic fine particles forming the metallic precursor film 4, is apt to occur by heating the metallic precursor film 4 in advance.

Although in Embodiment 9 the metallic precursor film is subjected to the heating treatment by the first laser light using the semiconductor laser having the wavelength of 830 nm and the power of 500 mW, this condition depends on factors such as the scan speed of the first and second laser light, the thickness of the metallic precursor film 4, the kind and diameter of metallic fine particles forming the metallic precursor film 4, a dispersing agent covering the circumference of individual metallic fine particles, etc., and thus an optimal condition may be determined in consideration of such factors. It should be here noted that the heating treatment of the metallic precursor film 4 is required to stop immediately before the fusing of metallic fine particles occurs. After forming the wiring pattern 17 on the metallic precursor film 4 by the irradiation and scan of the second laser light, the second laser light non-irradiated region 15 of the metallic precursor film 4 is rinsed and removed using the solvent of the metallic fine particle-dispersed liquid. However, if the heating treatment is carried out, under conditions such as occurrence of the fusing of metallic fine particles, the second laser light non-irradiated region 15 may not be cleaned and removed as it has already been metallized to form a film. As a result, an unintended metal film 14 is formed, which may raise short-circuit between intended wiring patterns 17. Therefore, the heating treatment under the conditions such as occurrence of the fusing of metallic fine particles is not preferable.

In addition, since the metallic precursor film 4 is heated with the first laser light and then the metallic precursor film 4 is made to be the metal film 14 with the second laser light, it goes without saying that energy density of the first laser light must be smaller than that of the second laser light. This is because the heated metal precursor film 4 is not changed to a metal film by the irradiation of the second laser light if the energy density of the first laser light is larger than that of the second laser light.

In addition, since the metallic precursor film 4 is heated by the irradiation of the first laser light and subsequently the metallic precursor film 4 is metallized by the irradiation of the second laser light, a first laser light irradiated region is preferably wider than a second laser light irradiated region in that relative positioning between the first laser light irradiated region and the second laser light irradiated region can be easily controlled. Although the first laser light irradiated region may have at least the same width as the second laser light irradiated region, it is effective to widen the heat treatment region by the first laser light and narrow the metallization region by the second laser light in that a control for laser light irradiation can be facilitated. That is, when the second laser light irradiated region is included in the first laser light irradiated region, the control for laser light irradiation can be facilitated.

Although in Embodiment 9 the laser light is used as a first energy ray, the first energy ray is not limited to the laser light but may be light that can add energy to heat the metallic precursor film 4 to a predetermined temperature. For example, an electron beam or an infrared light source may be used for the first energy ray. However, since the first energy ray is used for metal wiring, it is in many cases preferable to narrow the first energy ray irradiated region. From this standpoint, a laser light source that can easily narrow a light ray emitted from the first laser light source 22 by means of the optical system 24 is excellent in the aspect of ease use. In addition, laser light is apt to be selected since it has high selectivity including a semiconductor laser, a gas laser, etc., and has various kinds of wavelengths. In addition, selecting a laser light wavelength that can be well absorbed in the metallic precursor film 4 is effective in the heating treatment since the light ray emitted from the first laser light source 22 can be efficiently converted into heat in the metallic precursor film 4.

In addition, when the center of the first laser light irradiated region is placed on the substantially same position as the center of the second laser light irradiated region, it is ease to adjust or control irradiation energy of the first and second laser light. This is because the laser light has a Gaussian energy distribution having high intensity at its center. In other words, since the metallic precursor film 4 is heated with the first laser light and is metallized with the second laser light, when the center of the laser light irradiated region having the highest irradiation energy density is placed on the substantially same position, it is ease to adjust or control the irradiation energy of the laser light.

In addition, by placing the center of the second laser light irradiated region in the back of the center of the first laser light irradiated region in a scan direction, it is possible to increase time taken to heat the metallic precursor film 4 and it is ease to adjust the irradiation energy of the first laser light.

Although in Embodiment 9 the glass substrate is used as the substrate 1, without being limited to this, a ceramic substrate, a glass epoxy substrate, a flexible polyimide substrate, etc. which are being commonly used in a wiring board, may be used as the substrate 1.

Although in Embodiment 9 heating time is reduced, without being limited to this, laser power may be weakened with the heating time left alone. This is effective in forming a metal wiring substrate in a substrate having low heat resistance.

As described above, in Embodiment 9, by forming the metallic precursor film 4 on the substrate from the metallic fine particle-dispersed liquid 2, heating the metallic precursor film 4 by scan and irradiation of the first energy ray such as laser light under the conditions where there occurs no fusing of metallic fine particles, and forming the metal film 14 by scanning and irradiating the metallic precursor film 4 with the second energy ray such as the laser light, it is possible to form the metal wiring without using an expensive apparatus such as a photolithography apparatus. In addition, it is possible to form any wiring pattern having fine wiring width based on power of the laser light from the controller without using a mask such as a photomask. In addition, since time taken to form the wiring pattern can be reduced, it is possible to improve the productivity of the metal wiring substrate 16.

In addition, since the wiring pattern having high adhesion with the substrate can be formed without mixing a photothermal conversion material with the metallic fine particle-dispersed liquid 2 or providing a photothermal conversion layer between the substrate 1 and the metallic precursor film 4, it is possible to further simplify a process as compared to conventional metal wiring manufacturing methods. In addition, unlike Embodiment 8, since only a portion in which the wiring is formed can be heated, it is possible to easily remove the metallic precursor film 4 formed with no wiring. In addition, since the heating treatment and the energy ray scan and irradiation of the metallic precursor film 4 can be almost simultaneously performed, it is possible to further simplify a process of manufacturing the metal wiring substrate as compared to Embodiment 8.

### Embodiment 10

While in Embodiments 8 and 9 the metallic precursor film formed on the substrate is heated with heat or laser light, in Embodiment 10, a case where the metallic precursor film is irradiated with an ultraviolet ray will be described.

A method of manufacturing a metallic c wiring substrate of Embodiment 10 is similar to that shown Embodiment 8 except that the heating treatment step S12 of Embodiment is replaced with an ultraviolet irradiation step. The ultraviolet irradiation step is a step of irradiating the metallic precursor film formed on the substrate surface with an ultraviolet ray. This ultraviolet irradiation put metallic fine particles contained in the metallic precursor film 4 in a state immediately before the metallic fine particles are fused together.

Next, the metal wiring substrate manufacturing method of Embodiment 10 will be described in detail. First, the metallic fine particle-dispersed liquid 2 containing silver as metal is used. Like Embodiment 8, the metallic fine particle-dispersed liquid 2 is applied on a cleaned glass substrate 1 by spin coating. In more detail, as shown in FIG. 14 illustrating Embodiment 8, after the metallic fine particle-dispersed liquid 2 is dropped on the entire surface of the glass substrate 1 using a pipette 3, a film composed of the metallic fine particle-dispersed liquid 2 is formed on the surface of the glass substrate 1 by maintaining the glass substrate 1 for a predetermined period of time at a predetermined rotation speed, for example, for 30 seconds at a rotation speed of 1000 rotations/min. When the spin coating is performed after applying the metallic fine particle-dispersed liquid 2 on the glass substrate 1, extra metallic fine particle-dispersed liquid 2 is scattered and a portion of solvent of the metallic fine particle-dispersed liquid 2 remaining on the surface of the glass substrate 1 is evaporated to form a reddish brown metallic precursor film 4 on the surface of the glass substrate 1.

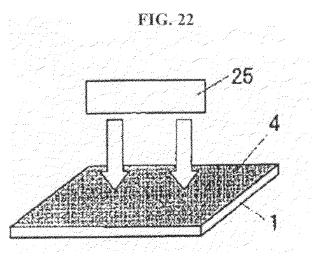

Subsequently, the metallic precursor film 4 formed on the surface of the glass substrate 1 is irradiated with an ultraviolet ray. FIG. 22 is a view showing a general configuration of an ultraviolet ray irradiation apparatus 10 according to Embodiment 10 of the present invention. In FIG. 22, reference numeral 25 denotes an ultraviolet lamp. The entire surface of the glass substrate 1 formed thereon with the metallic precursor film 4 is subjected to an ultraviolet irradiation treatment using the ultraviolet ray emitted from the ultraviolet lamp 25.

Subsequently, the surface of the metallic precursor film 4 subjected to the ultraviolet irradiation treatment is scanned and irradiated with an energy ray. Here, the laser light irradiation and scan apparatus 6 shown in FIG. 18 illustrating Embodiment 8 is used as an energy ray irradiation and scan apparatus.

Like Embodiment 8, by irradiating the metallic precursor film 4 with the laser light, the metallic precursor film 4 becomes the metal film 14, forming a metal pattern. However, the laser light non-irradiated region 15 is a metallic precursor film 4. Since this metallic precursor film 4 is an aggregate of metallic fine particles, it is an unstable material and thus it is preferable to remove it for use as the metal wiring substrate 16. The metallic precursor film 4 of the laser light non-irradiated region 15 may be removed by dipping the glass substrate 1 into the solvent used in the metallic fine particle-dispersed liquid 2. This is because the metallic precursor film 4 remaining in the glass substrate 1 can be swelled and easily removed by being dipped into the solvent used in the metallic fine particle-dispersed liquid 2. If it is difficult to remove the metallic precursor film 4, an ultrasonic cleaner may be used. Finally, when the substrate is rinsed with the same solvent as the solvent used in the metallic fine particle-dispersed liquid 2, the metal wiring substrate 16 is formed on the glass substrate 1.

In this manner, the metal wiring substrate 16 is formed by applying the metallic fine particle-dispersed liquid 2 on the substrate 1. Next, the following test sample was prepared in order to examine an ultraviolet irradiation treatment effect after forming the metallic precursor film 4 according to Embodiment 10 and a result of examination on electrical resistance of a wiring pattern 17 of the sample is shown. The wiring pattern 17 of the test sample is the same as the wiring pattern 17 shown in FIG. 20 illustrating Embodiment 8. Like Embodiment 8, a straight line portion 18 of the wiring pattern 17 is formed while changing a laser light irradiation and scan speed.

A polyimide resin substrate was used as the substrate 1, and the metallic fine particle-dispersed liquid 2 containing silver was used. After forming the metallic precursor film 4 on the polyimide resin substrate by applying the metallic fine particle-dispersed liquid 2 on the polyimide resin substrate by means of spin coating, the metallic precursor film 4 was subjected to the ultraviolet irradiation treatment. The ultraviolet irradiation treatment was carried out by irradiating the metallic precursor film 4 with an ultraviolet ray having a wavelength of 405 nm and power of 50 mW/cm² for 10 minutes to prepare the test sample of Embodiment 10. A plurality of test samples of Embodiment 10 subjected to such a heating treatment was formed.

In addition, like the test samples for Embodiment 10, the metallic precursor film 4 was formed on the polyimide resin substrate for comparative samples. Thereafter, a plurality of substrates formed thereon with the metallic precursor film 4 subjected to no ultraviolet irradiation treatment was formed as samples for Comparative Example 3.

Next, for the substrates of the samples of Embodiment 10 and Comparative Example 3, the metallic precursor film 4 was converted into the metal film 14 by laser light irradiation using the above-described laser light irradiation and scan apparatus 6 while changing a laser light irradiation and scan speed (moving speed of the substrate holder in the x direction). Finally, the laser light non-irradiated region 15 of the metallic precursor film 4 was dipped and removed into toluene as solvent of the metallic fine particle-dispersed liquid 2, and was rinsed, thereby preparing the samples of Embodiment 10 and the samples of Comparative Example 3. Next, electrical resistance between terminal portions 19 of the samples of Embodiment 10 and Comparative Example 3 was measured. Table 3 shows a result of measurement of electrical resistance for the samples of Embodiment 10 and Comparative Example 3.

TABLE 3

| Sample scan speed (mm/s) | 5 | 10 | 15 | 20 | 30 |
|---|---|---|---|---|---|
| Resistance of Embodiment 10 (Ω) | 8.5 | 8.7 | 8.7 | 8.6 | 8.9 |
| Resistance of Comparative | 8.6 | 8.6 | 9.2 | 9.8 | 20 |
| Example 3 (Ω) | | | | | |

As shown in Table 3, for the samples of Embodiment 10, the electrical resistance of the straight line portion is constant as about 8.7Ω even with increase of laser light irradiation and scan speed. On the other hand, for the samples of Comparative Example 3, the electrical resistance of the straight line portion tends to increase with increase of laser light irradiation and scan speed, finally leading to sudden increase.

For the samples of Embodiment 10, even with increase of laser light irradiation and scan speed, it is believed that the stable electrical resistance is due to the conversion of the metallic precursor film 4 into the metal film 14 by the irradiation of the laser light, that is, the mutual fusing of metallic fine particles forming the metallic precursor film 4, irrespective of the irradiation and scan speed of the samples. On the other hand, for the samples of Comparative Example 3, with increase of laser light irradiation and scan speed, it is believed that the increase of electrical resistance of the straight line portion 18 is due to incompletion of the conversion of the metallic precursor film 4 into the metal film 14 by the irradiation of the laser light, that is, the mutual fusing of metallic fine particles forming the metallic precursor film 4.

In actuality, from observation of surfaces of the samples, it is confirmed that the metal film 14 has a smooth surface irrespective of the irradiation and scan speed for the samples of Embodiment 10, while smoothness of the surface of the metal film 14 disappears with increase of the irradiation and scan speed for the samples of Comparative Example 3. In this manner, in Embodiment 10 that carries out the ultraviolet irradiation treatment before irradiating the metallic precursor film 4 with the laser light, it is possible to form the smooth metallic film 14 even with increase of the irradiation and scan speed of the laser light, unlike Comparative Example 3 that carries out no treatment before irradiating the metallic precursor film 4 with the laser light. It is believed that the reason for this is that the conversion of the metallic precursor film 4 into the metal film 14 by heating, that is, the thermal fusing of metallic fine particles forming the metallic precursor film 4, is apt to occur by irradiating the metallic precursor film 4 with the ultraviolet ray in advance.

Although in Embodiment 10 the metallic precursor film 4 is subjected to the ultraviolet irradiation treatment under the conditions of the wavelength of 405 nm, the power of 50 mW/cm², and irradiation time of 10 minutes, these conditions depend on factors such as the thickness of the metallic precursor film 4, the kind and diameter of metallic fine particles forming the metallic precursor film 4, a dispersing agent covering the circumference of individual metallic fine particles, etc., and thus optimal conditions may be determined in consideration of such factors.

Although in Embodiment 10 the polyimide resin substrate is used as the substrate 1, without being limited to this, a ceramic substrate, a glass epoxy substrate, etc. which are being commonly used in a wiring board, may be used as the substrate 1.

Although in Embodiment 10 the wiring thickness is small as 0.5 μm, the wiring thickness may become large by additionally forming a plating film on the wiring.

As described above, in Embodiment 10, by forming the metallic precursor film 4 on the substrate from the metallic fine particle-dispersed liquid 2, irradiating the metallic precursor film 4 with the ultraviolet ray, and forming the metal film 14 by scanning and irradiating the metallic precursor film 4 with the energy ray such as the laser light, it is possible to form the metal wiring without using an expensive apparatus such as a photolithography apparatus. In addition, it is possible to form any wiring pattern having fine wiring width based on power of the laser light from the controller without using a mask such as a photomask. In addition, since time taken to form the wiring pattern can be reduced, it is possible to improve the productivity of the metal wiring substrate 16.

In addition, since the wiring pattern having high adhesion with the substrate can be formed without mixing a photothermal conversion material with the metallic fine particle-dispersed liquid 2 or providing a photothermal conversion layer between the substrate 1 and the metallic precursor film 4, it is possible to further simplify a process as compared to conventional metal wiring manufacturing methods. In addition, unlike Embodiments 8 and 9, since there is no need to put the substrate formed thereon with the metallic precursor film 4 under a high-temperature circumference, even for a substrate having low heat resistance, it is possible to easily prepare wirings having high adhesion to the substrate 1 and uniform electrical resistance.

Although in Embodiments 8 and 10 the laser light is used as an energy ray and in Embodiment 9 the laser light is used as the second energy ray, the energy ray is not limited to the laser light but may be any light that can add energy to heat the metallic precursor film 4 and convert it into the metal film 14. For example, an electron beam or an infrared light source may be used for the energy ray. However, if a fine wiring pattern is required, it is in many cases preferable to narrow the energy ray irradiated region. From this standpoint, a laser light source that can easily narrow a light ray by means of the optical system 13 is excellent in the aspect of ease use. In addition, laser light is apt to be selected since it has high selectivity including a semiconductor laser, a gas laser, etc., and has various kinds of wavelengths. In addition, selecting a laser light wavelength that can be well absorbed in the metallic precursor film 4 is effective in converting the metallic precursor film 4 into the metal film 14 since the light ray emitted from the laser light source can be efficiently converted into heat in the metallic precursor film 4.

Although in Embodiments 8 to 10 the metallic fine particle-dispersed liquid 2 containing sliver and having the average diameter of 5 nm of the metallic fine particles is used, the average diameter of the metallic fine particles is not limited to 5 nm but may be less or more than 5 nm.

However, if the average diameter of the metallic fine particles is more than, for example, 20 nm, a dispersion state of metallic fine particles is deteriorated, and accordingly the metallic fine particles may be precipitated into the lower side of the metallic fine particle-dispersed liquid 2. This may need further energy required for conversion of the metallic precursor film 4 into the metal film 14, that is, a high temperature for metal film formation as temperature of thermal fusing of metallic fine particles is increased. On the contrary, if the average diameter of the metallic fine particles becomes small, activity of metallic fine particles increases, and accordingly fusing and cohesion of metallic fine particles contained in the metallic fine particle-dispersed liquid 2 are progressed, which may result in deterioration of uniformity of the metallic fine particle-dispersed liquid 2. As a result, the metallic precursor film 4 may become ununiform and accordingly the metal film 14 may become ununiform, which may result in ununiformity of wiring of the metal wiring substrate 16. Form the above description, the average diameter of the metallic fine particles may be determined based on reactivity of selected metal, temperature at which fusing of metal fine particles begins, etc.

As is apparent from the above description, the metal wiring substrate manufacturing method of the present invention is useful in applying metallic fine particles dispersed in an organic solvent on a substrate and patterning a metal film formed on the substrate into a desired shape.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2007-164619 filed on Jun. 22, 2007 and Japan Patent Application No. 2007-165812 filed on Jun. 25, 2007, the contents of which are incorporated herein for reference.

What is claimed is:

1. A pattern forming apparatus, comprising:
a liquid material application mechanism that includes an opening for applying a liquid material on a substrate; and
a laser processing mechanism that includes an irradiation section for irradiating the liquid material applied on the substrate with laser light to immobilize the liquid material so that a pattern is formed,
wherein the laser processing mechanism is integrated with the liquid material application mechanism.

2. The pattern forming apparatus according to claim 1, wherein the liquid material applied on the substrate is sequentially processed and immobilized by the laser light.

3. The pattern forming apparatus according to claim 1, wherein a diameter of a region having an energy level of the laser light at which the liquid material is substantially immobilized is greater than a minimum representative dimension of the opening.

4. The pattern forming apparatus according to claim 1, wherein a diameter of a region having an energy level of the laser light at which the liquid material is substantially immobilized is smaller than a minimum representative dimension of the opening.

5. The pattern forming apparatus according to claim 1, wherein the liquid material application mechanism applies a plurality of kinds of liquid materials on the substrate separately or in combination.

6. The pattern forming apparatus according to claim 1, wherein the irradiation section includes an optical fiber through which the laser light propagates.

7. The pattern forming apparatus according to claim 1, further comprising:
an atmosphere control chamber that is integrated with the opening and the irradiation section respectively.

8. The pattern forming apparatus according to claim 7, wherein the atmosphere control chamber is maintained under a low oxygen concentration atmosphere so that the liquid material is not oxidized.

9. The pattern forming apparatus according to claim 7, wherein the atmosphere control chamber is maintained under a high oxygen concentration atmosphere so that the liquid material is not reduced.

10. A pattern forming apparatus comprising:
a liquid material application mechanism that applies a liquid material on a substrate; and
a laser processing mechanism that irradiates and immobilizes the liquid material applied on the substrate with laser light,
wherein the liquid material application mechanism includes:
a liquid material supplying section which has an opening contacting the substrate through the liquid material; and
a transporting section which transports the liquid material to the liquid material supplying section;
wherein the laser processing mechanism includes an irradiation section which irradiates an irradiation target point with the laser light; and
wherein the liquid material is applied on the substrate from the opening and the liquid material applied on the substrate is sequentially processed and immobilized by the laser light emitted from the irradiation section.

11. A pattern forming method comprising:
applying a liquid material on a substrate through an opening while contacting the opening to the substrate through the liquid material; and
sequentially processing and immobilizing the liquid material applied on the substrate by the laser light to form a pattern.

12. The pattern forming method according to claim 11, wherein the laser light process induces a process of causing the liquid material to a chemical change or a physical change.

13. The pattern forming method according to claim 11, wherein the liquid material applied on the substrate is processed by first laser light and then is processed by second laser light.

14. The pattern forming method according to claim 13, wherein a wavelength of the first laser light is different from a wavelength of the second laser light.

15. The pattern forming method according to claim 13, wherein a beam profile of the first laser light is different from a beam profile of the second laser light.

16. The pattern forming method according to claim 11, wherein a first pattern is formed using a first liquid material, and then, a second pattern is formed using a second liquid material.

17. The pattern forming method according to claim 11, wherein, after forming the pattern, a part of the liquid material which is not immobilized in the liquid material applied on the substrate is removed; and
wherein a whole of the substrate is post-processed after the part of the liquid material is removed.

18. The pattern forming method according to claim 11, wherein the liquid material includes metal ions or metal colloids.

19. The pattern forming method according to claim 11, wherein the liquid material includes oxide fine particles.

20. The pattern forming method according to claim 11, wherein the liquid material includes a surface modifying material.
